(19) United States
(12) Patent Application Publication
(10) Pub. No.: US 2025/0227569 A1
(43) Pub. Date: Jul. 10, 2025

(54) COMMUNICATION DEVICE, COMMUNICATION SYSTEM, AND COMMUNICATION METHOD

(71) Applicants: SEIKO GROUP CORPORATION, Tokyo (JP); Tokyo University of Science Foundation, Tokyo (JP)

(72) Inventors: Ryosuke ISOGAI, Matsudo-shi (JP); Yoshifumi YOSHIDA, Matsudo-shi (JP); Mikio HASEGAWA, Tokyo (JP); Hiroyuki YASUDA, Tokyo (JP); Ryoma KITAGAWA, Tokyo (JP); Aohan Li, Tokyo (JP)

(21) Appl. No.: 18/701,836

(22) PCT Filed: Oct. 27, 2022
(86) PCT No.: PCT/JP2022/040130

§ 371 Date: Apr. 16, 2024

(30) Foreign Application Priority Data
Oct. 27, 2021 (JP) 2021-175223

(51) Int. Cl. H04W 36/00; H04W 24/02; H04W 52/02

(52) U.S. Cl. CPC H04W 36/0072; H04W 24/02; H04W 52/0261

(57) ABSTRACT

A communication device includes an internal state acquisition unit configured to acquire internal state information indicating an internal state of a first device from the first device, which is a device separate from the communication device, an internal state storage unit configured to store the acquired internal state information, a calculation unit configured to perform a process based on the stored internal state information, and an internal state output unit configured to output the internal state information stored in the internal state storage unit to a second device, which is a device separate from the first device, at a predetermined handover timing.

### TECHNICAL FIELD

The present invention relates to a communication device, a communication system, and a communication method.

Priority is claimed on Japanese Patent Application No. 2021-175223, filed Oct. 27, 2021, the content of which is incorporated herein by reference.

### BACKGROUND ART

Conventionally, in a wireless communication system including a transmission device and a reception device, there is a wireless communication method using a plurality of channels with different frequencies when information is transmitted from the transmission device to the reception device. In such a wireless communication system, there is technology for preventing unnecessary power consumption without using a detected channel when wireless communication interference is detected (see, for example, Patent Document 1).

### CITATION LIST

### Patent Document

Patent Document 1: Japanese Unexamined Patent Application, First Publication No. 2018-157429.

### SUMMARY OF INVENTION

### Technical Problem

However, in the above-described conventional technology, when the transmission device is replaced with a separate device due to reasons such as a fault and a product lifespan, the wireless communication interference is returned to a state in which the detected channel is used. Therefore, when the transmission device is replaced with another device, there is a problem that a learning result of the transmission device is not handed over to the other device and unnecessary power is consumed again. Such a problem is particularly problematic when the product lifespan of the transmission device is short.

Therefore, an objective of the present invention is to provide communication technology for enabling a transmission device to hand over a learning result to another device even if the transmission device is replaced with the other device.

### Solution to Problem

According to an aspect of the present invention, there is provided a communication device including: an internal state acquisition unit configured to acquire internal state information indicating an internal state of a first device from the first device, which is a device separate from the communication device; an internal state storage unit configured to store the acquired internal state information; a calculation unit configured to perform a process based on the stored internal state information; and an internal state output unit configured to output the internal state information stored in the internal state storage unit to a second device, which is a device separate from the first device, at a predetermined handover timing.

Also, in the communication device according to the aspect of the present invention, the internal state information stored in the internal state storage unit is updated on the basis of a process performed by the calculation unit.

Also, in the communication device according to the aspect of the present invention, the calculation unit includes a machine learning algorithm and the internal state information includes a learned parameter learned in the machine learning algorithm.

Also, in the communication device according to the aspect of the present invention, the machine learning algorithm is a reinforcement learning algorithm and the internal state information includes an action value function for use in the reinforcement learning algorithm.

Also, in the communication device according to the aspect of the present invention, the calculation unit calculates a communication parameter for performing information communication on the basis of the internal state information stored in the internal state storage unit, and the communication device further includes a wireless communication unit configured to perform the information communication corresponding to the communication parameter calculated by the calculation unit.

Also, the communication device according to the aspect of the present invention further includes a handover timing information acquisition unit configured to acquire handover timing information including information about the handover timing, wherein the internal state output unit outputs the internal state information on the basis of the information about the handover timing included in the acquired handover timing information.

Also, in the communication device according to the aspect of the present invention, the handover timing information acquisition unit acquires information about a battery level of a power supply for driving the communication device as the handover timing information, and the internal state output unit outputs the internal state information when the battery level is less than a predetermined threshold value.

Also, the communication device according to the aspect of the present invention further includes a fault determination unit configured to determine whether or not the communication device is in a fault state, wherein the handover timing information acquisition unit acquires a determination result of the fault determination unit as the handover timing information, and wherein the internal state output unit outputs the internal state information when the communication device is in the fault state.

Also, in the communication device according to the aspect of the present invention, the handover timing information includes information about a predetermined cycle and the internal state output unit outputs the internal state information at the predetermined cycle included in the handover timing information that has been acquired.

Also, in the communication device according to the aspect of the present invention, at a point in time when the internal state acquisition unit has acquired the internal state information, the calculation unit is in a dormant state and the internal state acquisition unit and the internal state output unit are not in the dormant state.

Also, according to an aspect of the present invention, there is provided a communication system including: the communication device according to the above-described aspect; and a relay device configured to transmit and receive the internal state information to and from one or more communication devices, wherein the relay device includes a relay information acquisition unit configured to acquire the internal state information output by the communication device as relay information; a relay information storage unit configured to store the relay information that has been acquired; and a relay information output unit configured to output the stored relay information as the internal state information to the communication device, and wherein the relay device is the second device.

Also, in the communication system according to the aspect of the present invention, the internal state output unit provided in the communication device outputs the internal state information to the relay device on the basis of a predetermined cycle, and the relay information output unit provided in the relay device outputs the relay information when the relay information acquisition unit has not acquired the internal state information from the communication device for a predetermined period or more.

Also, in the communication system according to the aspect of the present invention, the relay device further includes a shared relay information generation unit configured to generate shared relay information on the basis of the relay information acquired from a plurality of communication devices, the relay information storage unit stores the shared relay information as the relay information, and the relay information output unit outputs the shared relay information as the relay information.

Also, in the communication system according to the aspect of the present invention, the shared relay information generation unit generates the shared relay information using the acquisition of the relay information by the relay information acquisition unit as a trigger.

Also, the communication device according to the aspect of the present invention further includes a state storage unit configured to store state information which is information acquired at a specific moment among information items changing with at least one of a position of the communication device and a time, wherein the internal state storage unit stores information for use in calculation of the communication parameter and the state information as the internal state information in association, and wherein the calculation unit calculates the communication parameter on the basis of the state information stored in the state storage unit and the internal state information stored in the internal state storage unit.

Also, in the communication device according to the aspect of the present invention, the state storage unit stores a plurality of state information items acquired at a plurality of moments and the calculation unit decides on the communication parameter on the basis of the plurality of state information items that have been accumulated.

Also, according to an aspect of the present invention, there is provided a communication method including: an internal state acquisition step of acquiring internal state information indicating an internal state of a first device from the first device which is a device separate from an own device; an internal state storage step of storing the internal state information that has been acquired; a processing step of performing a process based on the stored internal state information; and an internal state output step of outputting the stored internal state information to a second device which is a device separate from the first device at a predetermined handover timing.

### Advantageous Effects of Invention

According to the present invention, a transmission device can hand over a learning result to another device when the transmission device is replaced with the other device.

### BRIEF DESCRIPTION OF DRAWINGS

FIG. 1 is a diagram for describing an example of a device configuration of a communication system according to a first embodiment.

FIG. 2 is a diagram for describing an example of information communication of the communication system according to the first embodiment.

FIG. 3 is a block diagram showing an example of a functional configuration of a transmission device according to the first embodiment.

FIG. 4 is a diagram for describing a series of operations of the transmission device according to the first embodiment.

FIG. 5 is a diagram for describing a search and utilization of communication parameters according to the first embodiment.

FIG. 6 is a timing chart showing an example of a timing of data transmitted by the transmission device according to the first embodiment.

FIG. 7 is a diagram for describing communication history information according to the first embodiment.

FIG. 8 is a diagram for describing an example of a configuration of a communication system according to a second embodiment.

FIG. 9 is a block diagram showing an example of a functional configuration of a transmission device according to the second embodiment.

FIG. 10 is a block diagram showing a first modified example of the functional configuration of the transmission device according to the second embodiment.

FIG. 11 is a block diagram showing a second modified example of the functional configuration of the transmission device according to the second embodiment.

FIG. 12 is a diagram for describing a handover between transmission devices according to the second embodiment.

FIG. 13 is a diagram for describing an example of a configuration of a communication system according to a third embodiment.

FIG. 14 is a diagram for describing a handover in a case where a relay device has performed a relay process according to the third embodiment.

FIG. 15 is a diagram for describing a proxy handover in a case where the relay device has performed a relay process according to the third embodiment.

FIG. 16 is a block diagram showing an example of a functional configuration of the relay device according to the third embodiment.

FIG. 17 is a block diagram showing a modified example of the functional configuration of the relay device according to the third embodiment.

### DESCRIPTION OF EMBODIMENTS

Hereinafter, embodiments of the present invention will be described with reference to the drawings. The embodiments to be described below are only examples and the embodiments to which the present invention applies are not limited to the following embodiments.

### First Embodiment

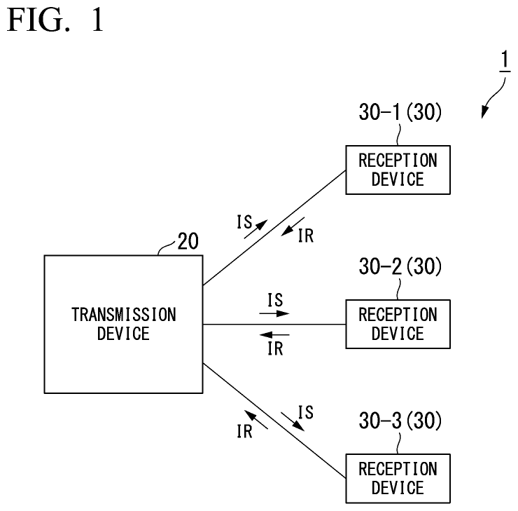

First, a first embodiment will be described with reference to FIGS. 1 to 7.

FIG. 1 is a diagram for describing an example of a device configuration of a communication system according to the first embodiment. The communication system 1 will be described with reference to the drawings.

### Communication System

The communication system 1 includes a transmission device 20 and a reception device 30. The transmission device 20 and the reception device 30 perform information communication with each other. The communication system 1 may include a plurality of transmission devices 20 and a plurality of reception devices 30. In this case, each transmission device 20 performs information communication with one or more reception devices 30. A case where one transmission device 20 and a plurality of reception devices 30 are provided will be described as an example of the communication system 1 with reference to FIG. 1. Specifically, a case where a reception device 30-1, a reception device 30-2, and a reception device 30-3 are provided as an example of the reception device 30 will be described.

The transmission device 20 and the reception device 30 perform information communication with each other through short-range wireless communication. An example in which the transmission device 20 and the reception device 30 perform wireless communication conforming to the standard of Bluetooth (registered trademark) (Bluetooth), particularly information communication based on wireless communication conforming to the standard of Bluetooth low energy (BLE), will be described below as an example of the short-range wireless communication.

The short-range wireless communication in the present embodiment is not limited to the example of BLE and various communication schemes can be employed. For example, the short-range wireless communication may be near field communication (NFC), Wi-Fi (registered trademark), infrared data association (IrDA), TransferJet (registered trademark), ZigBee (registered trademark), and the like. Alternatively, the wireless communication is not limited to a short range, but may be low power wide area (LPWA) or the like.

When the communication system 1 performs information communication based on wireless communication conforming to the BLE standard, the transmission device 20 may be peripheral and the reception device 30 may be central.

The transmission device 20, which is peripheral, transmits transmission information IS without identifying the reception device 30. The reception device 30 located in the vicinity of the transmission device 20 transmits reception information IR when the transmission information IS has been received.

The information communication performed between the transmission device 20 and the reception device 30 may be a communication method in which a plurality of communication channels are defined in a predetermined frequency band. For example, the transmission device 20 and the reception device 30 may exchange information using an advertising packet in wireless communication conforming to the BLE standard.

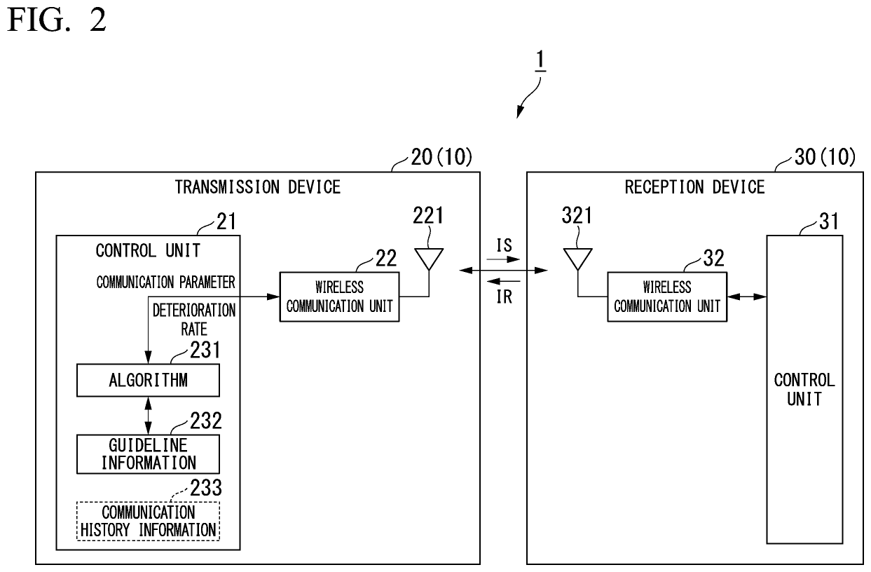

FIG. 2 is a diagram for describing an example of information communication in the communication system according to the first embodiment. An example of information communication performed between the transmission device 20 and the reception device 30 provided in the communication system 1 will be described with reference to FIG. 2.

The transmission device 20 transmits transmission information IS on the basis of communication parameters calculated in an algorithm 231. The communication parameters may include, for example, a frequency band for use in communication, a signal transmission interval, a transmission count, transmission power, or the like.

The transmission device 20 includes a control unit 21 and a wireless communication unit 22.

The wireless communication unit 22 controls radio waves to be transmitted from an antenna 221 on the basis of the communication parameters acquired from the control unit 21. Also, the wireless communication unit 22 outputs information based on the radio waves received by the antenna 221 to the control unit 21.

The control unit 21 includes the algorithm 231 and calculates the communication parameters. The control unit 21 includes the algorithm 231 to calculate the communication parameters on the basis of communication history information 233. The control unit 21 updates the calculated communication parameters as guideline information 232 at any time. The control unit 21 outputs the calculated communication parameters to the wireless communication unit 22.

Also, the control unit 21 acquires information of radio waves received by the antenna 221 from the wireless communication unit 22. The control unit 21 updates the guideline information 232 on the basis of a deterioration rate included in the acquired radio wave information.

The deterioration rate is a value indicating a degree of deterioration of communication quality, and may be calculated on the basis of, for example, whether or not the transmission information IS transmitted by the transmission device 20 has reached one of the reception devices 30. That is, the deterioration rate may be a value indicating whether or not communication between the transmission device 20 and the reception device 30 has been successful. In this case, the deterioration rate may be binary. When the deterioration rate is binary, the control unit 21 is calculated according to a control signal (for example, an ACK signal or the like) that is returned when the reception device 30 has correctly received the transmission information IS or the like.

As another embodiment of the control signal, the presence or absence of a scan response request for the BLE advertising packet may be used as the deterioration rate, and the presence or absence of a connection request from the central device (i.e., the reception device 30) may be used as the deterioration rate. The reception device 30 may convey whether or not the transmission information IS has been correctly received using different communication means without involving wireless communication. The control unit 21 sets a low deterioration rate when the reception device 30 has correctly received the transmission information IS. The control unit 21 may set the deterioration rate to 0 (zero) when the reception device 30 has correctly received the transmission information IS.

Also, in another embodiment, the deterioration rate may be based on information about the strength of radio waves contained in the radio waves received by the antenna 221 from the reception device 30. The information about the strength of the radio waves may be, for example, a received signal strength indicator (RSSI) or the like. In this case, the reception device 30 includes a radio wave strength measurement unit (not shown) and measures the radio wave strength when receiving the transmission information IS. The reception device 30 transmits the measured radio wave strength to the transmission device 20 as reception information IR. The control unit 21 sets the deterioration rate to a higher rate when the radio wave strength included in the received reception information IR is lower. That is, it is indicated that the radio waves transmitted to the reception device 30 do not deteriorate as the deterioration rate decreases.

Furthermore, as another embodiment, the deterioration rate may be calculated from an error rate when the reception device 30 has received information encoded with an error detection code or an error correction code. In this case, the control unit 31 provided in the reception device 30 calculates the error rate of the transmission information IS acquired from the transmission device 20. The reception device 30 transmits the calculated error rate as the reception information IR to the transmission device 20. The control unit 21 provided in the transmission device 20 sets the deterioration rate to a higher rate when the error rate included in the received reception information IR is higher.

In other words, a signal transmitted to the reception device 30 on the basis of the output communication parameters is encoded in an encoding scheme having an error detection function and the deterioration rate is based on the error rate when a signal received from the reception device 30 has been decoded.

The reception device 30 includes a control unit 31 and a wireless communication unit 32.

The wireless communication unit 32 receives radio waves from the transmission device 20 via the antenna 321. The control unit 31 calculates the radio wave strength (RSSI) of the received radio waves, the error rate, and the like on the basis of received radio wave information input from the wireless communication unit 32. The wireless communication unit 32 outputs the radio wave strength, the error rate, and the like calculated by the control unit 31 as the reception information IR.

Here, the transmission device 20 and the reception device 30 may have similar device configurations. That is, in the communication system 1, a device that performs the behavior of the transmission side at a certain point in time is referred to as the transmission device 20 and a device that receives radio waves transmitted by the transmission device 20 is referred to as the reception device 30. In the following description, when the transmission device 20 and the reception device 30 are not distinguished, they are also referred to as the communication device 10.

### Functional Configuration of Transmission Device

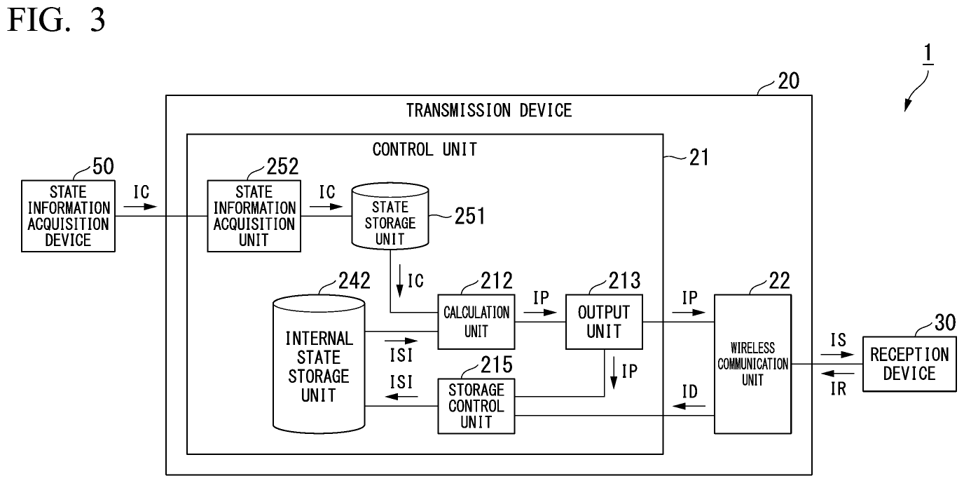

FIG. 3 is a block diagram showing an example of the functional configuration of the transmission device according to the first embodiment. An example of the functional configuration of the transmission device 20 will be described with reference to FIG. 3. The components already described in the description of the communication system 1 are denoted by similar reference signs and description thereof may be omitted.

The transmission device 20 includes a control unit 21 and a wireless communication unit 22. The transmission device 20 includes a storage device such as a central processing unit (CPU), a read-only memory (ROM), or a random access memory (RAM) connected by a bus and the like, and functions as a device including the control unit 21 and the wireless communication unit 22 by executing a transmission program.

The control unit 21 includes an internal state storage unit 242, a calculation unit 212, an output unit 213, a storage control unit 215, a state storage unit 251, and a state information acquisition unit 252.

In addition, all or some functions of the transmission device 20 may be implemented using hardware such as an application-specific integrated circuit (ASIC), a programmable logic device (PLD), or a field-programmable gate array (FPGA). The transmission program may be recorded on a computer-readable recording medium. The computer-readable recording medium is, for example, a flexible disk, a magneto-optical disc, a ROM, a portable medium such as a CD-ROM, or a storage device such as a hard disk built into a computer system. The transmission program may be transmitted via a telecommunication circuit.

The state storage unit 251 stores a state information IC. The state information IC is information acquired at a specific moment among information items changing in accordance with at least one of the position and time of the own device. The state information IC may be, for example, time information indicating the time, position information indicating the position of the own device, information of environments around the own device, and the like.

In addition, the position information indicating the position of the own device may be position information indicating the position of the own device in a three-dimensional space or position information indicating the position of the own device in the two-dimensional coordinate information. In the case of two-dimensional coordinate information, height (altitude) information is not required.

When the state information IC is time information, for example, the state storage unit 251 may store the current time measured by a time measurement unit (not shown) provided in the transmission device 20. The time information may be updated by the time measurement unit.

When the state information IC is position information, for example, it may be position coordinates acquired using a positioning system. The position coordinates are acquired by a Global Positioning System (GPS) communication unit (not shown) provided in the transmission device 20. The GPS communication unit receives radio waves from satellites such as GPS devices. The position of the own device is measured with the received radio waves.

When the state information IC is environmental information, for example, the state storage unit 251 stores environmental information such as temperature, humidity, illuminance, ultraviolet rays (UV), atmospheric pressure, noise, and acceleration. The state information IC is acquired by environmental sensors (an environmental information acquisition unit) such as a temperature sensor, humidity sensor, illuminance sensor, ultraviolet sensor, barometric pressure sensor, noise sensor, and acceleration sensor, which are not shown, provided in the transmission device 20 in accordance with a type of environmental information.

In addition, the time measurement unit, the GPS communication unit, and the environmental sensor may be provided outside of the transmission device 20. In this case, the transmission device 20 acquires the state information IC from the time measurement unit, the GPS communication unit, and the environmental sensor that are externally provided.

When the transmission device 20 acquires the state information IC via Wi-Fi, the position information may be estimated on the basis of information of a connected access point. Also, the position information may be estimated on the basis of information of a position of the access point and information of a distance from the access point to the own device. That is, the position information may be estimated on the basis of radio waves for acquiring the state information IC.

Also, the position information may be estimated on the basis of radio waves for performing information communication different from radio waves for acquiring the state information IC. That is, the position information may be estimated on the basis of both or one of the radio waves for acquiring the state information IC and the radio waves for performing the information communication.

When the devices for acquiring the state information IC such as the time measurement unit, the GPS communication unit, and the environmental information acquisition unit are not distinguished, they are also referred to as a state information acquisition device 50.

The state information acquisition unit 252 may acquire the state information IC from the state information acquisition device 50.

In addition, the state storage unit 251 may store a plurality of state information items IC acquired at a plurality of moments. That is, the state storage unit 251 may store a history of the state information IC.

The internal state storage unit 242 stores the internal state information ISI. Internal state information ISI is information in which information for use in calculating a communication parameter PM to be used when the transmission device 20 performs information communication is associated with the state information IC. The information for use in calculating the communication parameter PM may be, for example, a learned parameter learned in a machine learning algorithm, or an action value function for use in a reinforcement learning algorithm.

In addition, the internal state storage unit 242 may function as a communication history information storage unit 211 that stores communication history information IH.

Here, the communication history information IH is an example of the internal state information ISI. The communication history information IH is information in which a communication parameter PM for performing information communication is associated with a deterioration rate D when information communication is performed using the communication parameter PM. The deterioration rate D is a value based on the radio waves transmitted using the communication parameter PM when information is transmitted to the reception device 30 and the radio waves received from the reception device 30. For example, the deterioration rate D may be defined by the deterioration rate D=(radio wave strength of received radio waves/radio wave strength of transmitted radio waves). The communication history information storage unit 211 may include a volatile RAM or a non-volatile ROM.

The calculation unit 212 calculates the communication parameter PM on the basis of the state information IC stored in the state storage unit 251 and the internal state information ISI stored in the internal state storage unit 242. When a plurality of state information items IC are stored in the state storage unit 251, the calculation unit 212 decides on the communication parameter PM on the basis of the plurality of state information items IC that have been accumulated.

When the state information IC is information indicating a time, information corresponding to the time indicated in the state information IC is acquired from the internal state storage unit 242 and the communication parameter PM is calculated on the basis of the acquired information. That is, the calculation unit 212 calculates the communication parameter PM on the basis of information stored in the internal state storage unit 242 and corresponding to the time indicated in the state information IC stored in the state storage unit 251.

Likewise, when the state information IC is information indicating environmental information, information corresponding to the environmental information indicated in the state information IC is acquired from the internal state storage unit 242 and the communication parameter PM is calculated on the basis of the acquired information. That is, the calculation unit 212 calculates the communication parameter PM on the basis of information stored in the internal state storage unit 242 and corresponding to the environmental information indicated in the state information IC stored in the state storage unit 251.

Likewise, when the state information IC is information indicating the position information of the own device, information corresponding to the position information indicated in the state information IC is acquired from the internal state storage unit 242 and the communication parameter PM is calculated on the basis of the acquired information. That is, the calculation unit 212 calculates the communication parameter PM on the basis of information stored in the internal state storage unit 242 and corresponding to the position information indicated in the state information IC stored in the state storage unit 251.

As another example of the state information IC, the state information IC may be image information obtained by imaging the surroundings of the own device or audio information collected and recorded around the own device. In this case, the state information acquisition unit 252 acquires the image information or the audio information from a camera or microphone (not shown).

In this case, the calculation unit 212 performs an estimation process on the basis of the acquired image information and calculates the communication parameter PM on the basis of an estimation result. Likewise, the calculation unit 212 performs an estimation process on the basis of the acquired audio information and calculates the communication parameter PM on the basis of the estimation result.

Also, the calculation unit 212 may estimate a congestion situation of radio waves from the state information IC and calculate the communication parameter PM on the basis of the estimated congestion situation. That is, the calculation unit 212 estimates the congestion situation of radio waves around the own device from the state information IC stored in the state storage unit 251 and calculates the communication parameter IC on the basis of the estimated congestion situation IC.

Also, the calculation unit 212 may estimate a density of people instead of the congestion situation of radio waves. In this case, the calculation unit 212 estimates the density of people around the own device from the state information IC stored in the state storage unit 251 and calculates the communication parameter PM on the basis of the estimated density of people.

As another example of the state information IC, the state information IC may be information indicating the weather around the own device. When the state information IC is information indicating the weather around the own device, the calculation unit 212 acquires information corresponding to the information indicating the weather indicated in the state information IC from the internal state storage unit 242, and calculates the communication parameter PM on the basis of the acquired information. That is, the calculation unit 212 calculates the communication parameter PM on the basis of information stored in the internal state storage unit 242 and corresponding to information indicating the weather indicated in the state information stored in the state storage unit 251.

Here, information indicating the weather includes information about weather such as temperature, humidity, visibility, wind, cloud cover, rain, snow, and lightning, and is acquired by various types of sensors (not shown). Alternatively, the information may be acquired from the outside in some communication method.

The calculation unit 212 calculates the communication parameter PM using a machine learning algorithm. The machine learning algorithm may be, for example, a reinforcement learning algorithm using state information such as Q learning or deep reinforcement learning. When the machine learning algorithm is a reinforcement learning algorithm, the communication parameter PM for maximizing the reward is learned using the value calculated from the deterioration rate D as a reward in the machine learning algorithm. In addition, when the deterioration rate D is higher, the smaller reward value is preferable.

Here, the machine learning algorithm may be a pre-trained model. In addition, at the time of the initial operation, the machine learning algorithm may not be trained. Therefore, when the machine learning algorithm is untrained, a result may be determined according to a random number.

The machine learning algorithm is learned on the basis of the communication history information IH. The communication history information IH is information in which the communication parameter PM output by the output unit 213 is associated with the deterioration rate D obtained as a result of information communication using the communication parameter PM. That is, the calculation unit 212 is trained on the basis of the deterioration rate D obtained as a result of information communication using the communication parameter PM output by the output unit 213.

In addition, the internal state storage unit 242 may store a plurality of internal state information items ISI. In this case, the calculation unit 212 calculates the communication parameter PM on the basis of the internal state information ISI corresponding to the state information IC stored in the state storage unit 251 among the plurality of internal state information items ISI that have been stored.

The calculation unit 212 outputs parameter information IP including the calculated communication parameter PM to the output unit 213.

The output unit 213 outputs the parameter information IP including the communication parameter PM calculated by the calculation unit 212 to the wireless communication unit 22.

The wireless communication unit 22 performs information communication with the reception device 30 on the basis of the communication parameter PM included in the parameter information IP output by the output unit 213.

The storage control unit 215 acquires deterioration information ID including the deterioration rate D from the wireless communication unit 22. The storage control unit 215 associates the acquired deterioration information ID with the communication parameter PM and causes the communication history information storage unit 211 to store an association result as communication history information IH. The storage control unit 215 acquires parameter information IP from at least one of the output unit 213 and the wireless communication unit 22, generates the communication history information IH by associating the communication parameter PM included in the acquired parameter information IP with the deterioration rate D, and causes the communication history information storage unit 211 to store the generated communication history information IH.

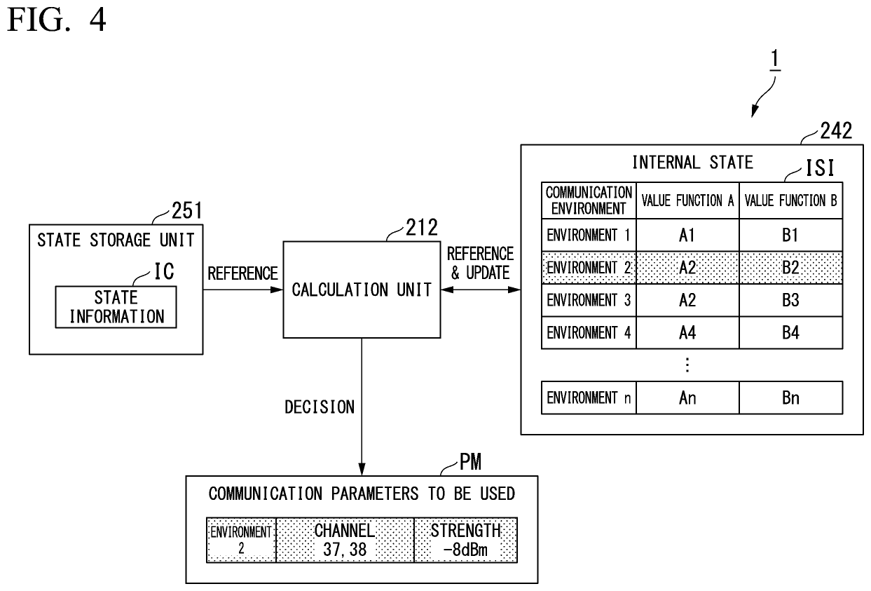

FIG. 4 is a diagram for describing a series of operations of the transmission device according to the first embodiment. An example of the operation of the transmission device 20 will be described with reference to the drawings.

The calculation unit 212 refers to the state information IC stored in the state storage unit 251 and the internal state information ISI stored in the internal state storage unit 242 and decides on the communication parameter PM.

Here, an example of the internal state information ISI will be described. The internal state information ISI is information in which “communication environment,” “value function A,” and “value function B” are associated. The “communication environment” is information corresponding to a type of state information IC. When the state information IC is time information, the “communication environment” is information about the time. When the state information IC is position information, the “communication environment” is information about the position. When the state information IC is environmental information, the “communication environment” is information about the environment.

Both “value function A” and “value function B” may be action value functions in reinforcement learning.

In an example shown in FIG. 4, environment 1 as “communication environment,” A1 as “value function A,” and B1 as “value function B” are associated, environment 2 as “communication environment,” A2 as “value function A,” and B2 as “value function B” are associated, environment 3 as “communication environment,” A3 as “value function A,” and B3 as “value function B” are associated, environment 4 as “communication environment,” A4 as “value function A” and B4 as “value function B” are associated, . . . , and environment n as “communication environment,” An as “value function A,” and Bn as “value function B” are associated (n is a natural number greater than or equal to 1).

The calculation unit 212 acquires the state information IC from the state storage unit 251, selects a value function according to the communication environment on the basis of the state information IC and the internal state information ISI, and decides on the communication parameter PM on the basis of the selected value function.

The communication parameter PM includes, for example, a communication channel and a communication strength.

In the example shown in FIG. 4, a value function corresponding to environment 2 is selected and the communication channel and the communication strength are decided on the basis of the selected value function. Specifically, channel 37 and channel 38 are decided on as the communication channel and −8 [dBm] is decided on as the communication strength.

The calculation unit 212 updates the internal state information ISI stored in the internal state storage unit 242 in accordance with the parameters used for communication and the communication result.

In this way, the calculation unit 212 derives an optimal communication parameter at a point in time when information communication is performed while “search,” which is an operation of learning suitable communication parameters, and “utilization,” which is an operation of performing communication using the communication parameter PM decided on in the search, are iterated.

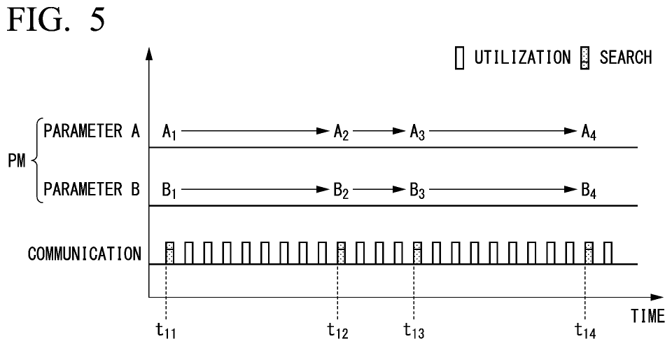

FIG. 5 is a diagram for describing the search and utilization of communication parameters according to the first embodiment. “Search” and “utilization” of the algorithm 231 will be described with reference to FIG. 5. The algorithm 231 is an example of the calculation unit 212.

“Parameter A” and “parameter B” are examples of communication parameters PM. That is, in one example described with reference to FIG. 5, the number of communication parameters PM is two. The time variation of each parameter is shown with the horizontal axis representing time. “Communication” indicates whether “search” or “utilization” is being performed in the algorithm 231 with the horizontal axis representing time. “Search” is indicated by a rectangle shaded in black and “utilization” is indicated by an unshaded rectangle.

At time t₁₁, “search” is performed in the algorithm 231. In the algorithm 231, the value of parameter A is decided on as “A₁” and the value of parameter B is decided on as “B₁.” During a period from time t₁₁ to time t₁₂, the transmission device 20 performs information communication using the decided communication parameter PM. That is, during a period from time t₁₁ to time t₁₂, “utilization” is performed.

At time t₁₂, “search” for a more suitable communication parameter PM is performed in the algorithm 231 on the basis of the accumulated communication history information IH as a “utilization” result during the period from time t₁₁ to time t₁₂. As a search result, a change of the value of parameter A from “A₁” to “A₂” and a change of the value of parameter B from “B₁” to “B₂” are decided on in the algorithm 231. During a period from time t₁₂ to time t₁₃, the transmission device 20 performs information communication using the decided communication parameter PM.

At time t₁₃, “search” for a more suitable communication parameter PM is performed on the basis of a result of “utilization” and the accumulated communication history information IH during a period from time t₁₁ to time t₁₂ and a period from time t₁₂ to time t₁₃ in the algorithm 231. As a search result, a change of the value of parameter A from “A₂” to “A₃” and a change of the value of parameter B from “B₂” to “B₃” are decided on in the algorithm 231. During a period from time t₁₃ to time t₁₄, the transmission device 20 performs information communication using the decided communication parameter PM.

As described above, in the algorithm 231, a suitable communication parameter PM is derived and information communication is performed on the basis of the derived communication parameter PM while “search” and “utilization” are iterated.

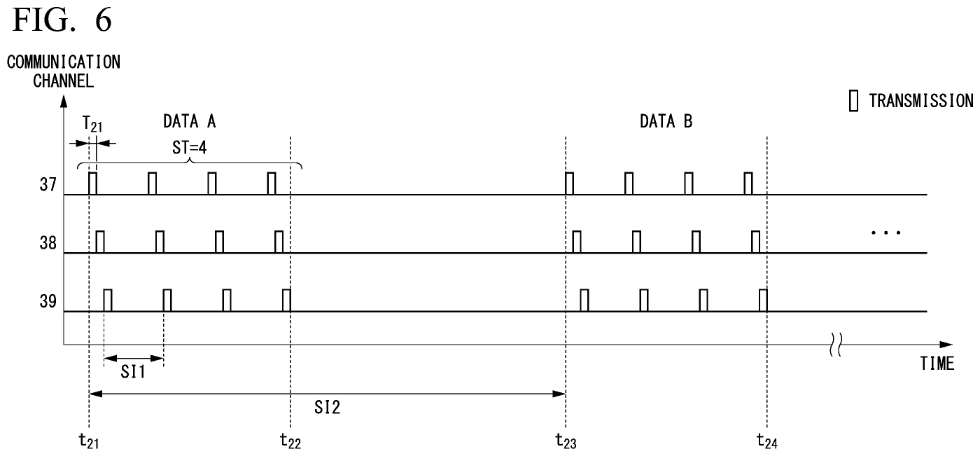

Also, in the example shown in FIG. 6, time t₁₁, time t₁₂, time t₁₃, and time t₁₄, which are the timings for performing “search,” are predetermined timings decided on in the algorithm 231. The timing at which “search” is performed may be irregular, as in the present example, or may be a regular timing.

The algorithm 231 is specifically a machine learning algorithm. More specifically, the algorithm 231 may be a multi-armed bandit (MAB) algorithm or the like. That is, the calculation unit 212 may be trained using the MAB algorithm.

By using the MAB algorithm, the transmission device 20 can reliably transmit information to the reception device 30 with small power consumption.

### MAB Algorithm

Hereinafter, the MAB algorithm will be described. The MAB algorithm is an algorithm used to solve the problem of maximizing the reward within a limited number of trials when there are multiple slot machines where the probability of getting a reward is not clear. In order to decide on a suitable communication parameter PM using this MAB algorithm, an amount of reward must be set in consideration of the trade-off between the power consumption required for transmission and whether or not the reception device 30 has correctly received information.

The transmission device 20 acquires an amount of power required for communication in a predetermined method. The transmission device 20, for example, may include a power measurement device (not shown) to measure actual power consumption. Also, the transmission device 20 may store a power consumption correspondence table (not shown) in which the communication parameter PM and the power consumption estimation amount are associated and acquire the amount of power with reference to the power consumption correspondence table.

Because it is more preferable to have less power consumption, it is desirable to decrease the amount of reward as the power consumption increases. By decreasing the amount of reward as the power consumption increases, it is possible to suppress an amount of power required for transmission by deciding on the communication parameter PM to reduce the power consumption in the algorithm 231, which is a MAB algorithm. Because it is indicated that information can be transmitted with high quality (i.e., reliably) as the deterioration rate D decreases, it is desirable to increase the amount of reward as the deterioration rate D decreases.

In the algorithm 231, communication history information IH is constructed using the calculated deterioration rate D. For example, the communication history information IH may be time-series data with a deterioration rate D. In the algorithm 231, a suitable communication parameter PM is decided on the basis of the communication history information IH, which is time-series data of the deterioration rate D.

In addition, the communication history information IH may be a single value calculated on the basis of the deterioration rate D accumulated in the past.

As another example, instead of an example in which the communication history information IH is held in the transmission device 20, the communication history information IH may be acquired from another device. The other device may be, for example, the reception device 30. That is, in another example, the reception device 30 holds the communication history information IH instead of the transmission device 20. In this case, the reception device 30 may count the number of times information could be received from the transmission device 20 without missing information and estimate the deterioration rate on the basis of the counted number of times. In this case, the reception device 30 transmits the communication history information IH to the transmission device 20 at a predetermined timing.

Also, when the communication parameter PM has a plurality of parameters as its components and the parameters include discrete values, it is possible to select one from all possible combinations capable of being taken by the communication parameter PM in the algorithm 231. That is, the communication parameter PM is calculated by selecting one combination from among the combinations of a plurality of components included in the communication parameter PM in the algorithm 231.

Specifically, a case where the communication parameter PM has component x, component y, and component z will be described. For example, if the component x is a ternary value of x1, x2, and x3, the component y is a binary value of y1 and y2, and the component z is a ternary value of z1, z2, and z3, it is possible to decide on the communication parameter PM by selecting one of 18 (3×2×3) combinations in the algorithm. According to a configuration in this way, it is possible to easily and optimally select a communication parameter PM composed of a plurality of elements in the algorithm 231.

Here, the algorithm 231 can use an upper confidence bound (UCB) 1 algorithm when it is a combination of communication parameters PM that is somewhat complex. In this case, the calculation unit 212 is trained using the UCB1 algorithm.

Also, the algorithm 231 can use a lighter tug of war (TOW) algorithm when it is necessary to perform an operation with a microcontroller with low specifications. In this case, the calculation unit 212 is trained using a TOW algorithm.

In addition, the UCB1 algorithm herein includes a UCB1 algorithm and a UCB1-tuned algorithm.

### Communication Parameters

FIG. 6 is a timing chart showing an example of a timing of data transmission of the transmission device according to the embodiment. Specific components of the communication parameters PM will be described with reference to FIG. 6. In this example, the communication parameter PM has “communication channel,” “first transmission interval SI1,” “second transmission interval SI2,” “transmission count ST,” and “transmission power” as the components thereof. In the example shown in FIG. 6, three channels of 37 ch (2402 MHz), 38 ch (2426 MHz), and 39 ch (2480 MHz), which are advertising channels used for advertising BLE, are used as “communication channel.” In FIG. 6, the horizontal axis is shown as a time axis with respect to a change in data to be transmitted on each channel over time.

During a period from time t₂₁ to time t₂₂, the wireless communication unit 22 sequentially outputs data A to each of the 37 ch, 38 ch, and 39 ch. Period T₂₁ is a period required for transmitting data A.

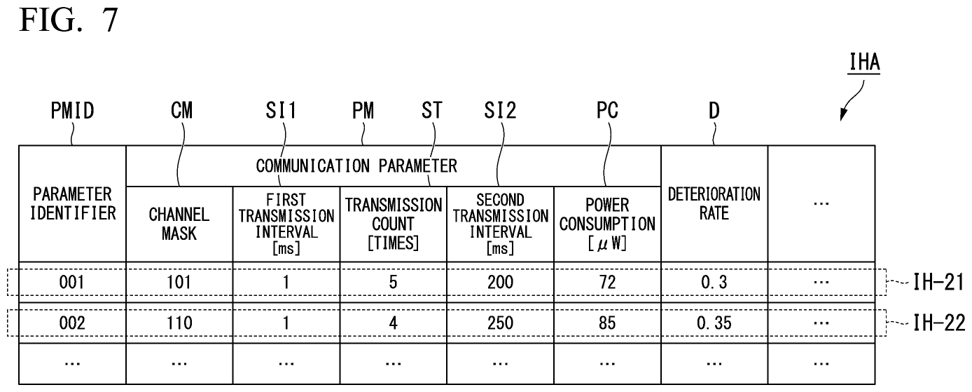

Specifically, the wireless communication unit 22 outputs data A to 37 ch at time t₂₁, subsequently outputs data A to 38 ch, and subsequently outputs data A to 39 ch. After outputting data A to each channel, the wireless communication unit 22 outputs data A to each channel again at the first transmission interval SI1. This is iterated until the predetermined transmission count ST is reached. According to an example shown in FIG. 7, because the transmission count ST is 4, the same data is output four times per channel.

That is, the communication parameter PM includes the first transmission interval SI1, and the wireless communication unit 22 transmits a signal to the reception device 30 on the basis of the first transmission interval SI1.

Here, the first transmission interval SI1 is an interval at which the same data is transmitted to each channel. According to BLE, the advertisement process is a process that is performed for each of the plurality of advertising channels. For example, the advertisement process is separately performed for three advertising channels of 37 ch, 38 ch, and 39 ch. Here, each channel may interfere with other radio waves present in space. When interference has occurred on all three channels or when the reception device 30 is not ready for reception, a situation in which the information transmitted by the transmission device 20 does not reach the reception device 30 occurs. In preparation for such a situation, a packet obtained by encoding the same data is regularly transmitted multiple times.

Also, a case where the reception device is not ready for reception is a case where a reception operation is performed intermittently to reduce power consumption at the BLE reception side (the central device) or the like.

The wireless communication unit 22 begins to output data A at time t₂₁ and then begins to output data B different from data A after the elapse of the second transmission interval SI2. That is, during a period from time t₂₃ to time t₂₄, the wireless communication unit 22 outputs data B to 37 ch, 38 ch, and 39 ch. The second transmission interval SI2 is an interval until the data is updated and newly transmitted.

Here, the wireless communication unit 22 completes the information transmission process for the reception device 30 during a transmission time period, which is a period of time from the start of signal generation to the end of transmission.

The calculation unit 212 may adjust the communication parameter PM so that the transmission time period is reduced when the reception device 30 has continuously and stably received the information transmitted by the wireless communication unit 22. In this case, the calculation unit 212 may adjust the communication parameter PM so that the transmission time period is reduced on the basis of information included in the reception information IR received from the reception device 30.

In addition, when the reception device 30 has continuously and stably received the information transmitted by the wireless communication unit 22, the determination may be made by the reception device 30 or the transmission device 20. When the determination is made by the transmission device 20, the determination may be made on the basis of whether or not there is reception information IR that is a response to the transmission information IS.

Also, the wireless communication unit 22 iteratively performs a transmission process during a period from the time of system activation to an assumed operating lifespan. The system may be, for example, a system that operates the transmission device 20, and the time of activation of the system may be the time when the transmission device 20 was powered on. The time when the transmission device 20 was powered on may be the time when the power was first turned on before factory shipments or may be the time when the power was first turned on after factory shipments.

In this case, the calculation unit 212 adjusts the communication parameter PM to reduce a total time period required for the information transmission process when the reception device 30 has continuously and stably received the information transmitted by the wireless communication unit 22. The calculation unit 212 may adjust the communication parameter PM to reduce the total time period required for the information transmission process on the basis of the information included in the reception information IR received from the reception device 30.

Also, the wireless communication unit 22 transmits first data (data A) obtained by encoding the same data until a certain transmission count ST is reached on the basis of the first transmission interval SI1 and then transmits second data (data B) different from the first data on the basis of the second transmission interval SI2. Further, third, fourth, . . . , n^{th} data (n is a natural number of 1 or more) that are different from each other may be transmitted on the basis of the second transmission interval SI2 that is continuous.

In this case, the communication parameters PM include the second transmission interval SI2 and the transmission count ST.

Also, the calculation unit 212 adjusts the communication parameter PM to reduce the transmission count ST when the reception device 30 has continuously and stably received the information transmitted by the wireless communication unit 22. The calculation unit 212 may adjust the communication parameter PM to reduce the transmission count ST on the basis of information included in the reception information IR received from the reception device 30.

When the communication parameters PM include the second transmission interval SI2 and when the reception device 30 has continuously and stably received the information transmitted by the wireless communication unit 22, the communication parameter PM may be adjusted to increase the second transmission interval SI2. Also, the calculation unit 212 may adjust the communication parameter PM to increase the second transmission interval SI2 when the information transmitted by the wireless communication unit 22 has not been continuously received by the reception device 30. Also, when the communication environment is improved and data can be stably received, the second transmission interval SI2 may be reduced or returned to the original value. By decreasing the second transmission interval SI2 or returning the second transmission interval SI2 to the original value, a period of time until the connection with the reception device 30 is made can be shortened, and the connection can be stably made.

Also, the second transmission interval SI2 may be reduced when data with high urgency is transmitted. Thereby, it is possible to suppress power consumption when normal data is transmitted and transmit data to the reception device 30 without delay when data with high urgency is transmitted.

### Channel Mask

Next, a channel mask that is an example of the communication parameter PM will be described. The channel mask is a communication parameter for determining the channel to be used when a communication method in which a plurality of channels are defined in a used band is used. When a communication method in which a plurality of channels are defined in the used band is used, a channel mask for determining the channel to be used may be included as the communication parameter PM.

In other words, the channel designated by the channel mask may be a channel that is not used for communication. Specifically, when the communication method in the present embodiment is advertising defined in the BLE standard, the communication channel may be an advertising channel defined in the BLE standard. Advertising may be connectable advertising. The deterioration rate D may be a value calculated on the basis of whether or not the connection request has been answered.

The calculation unit 212 decides on the communication parameter PM so that the deterioration rate D is reduced when communication with the reception device 30 of the specific other party is performed via a channel mask included in the calculated communication parameter PM.

For example, the BLE advertisement process is separately performed for three advertising channels 37, 38, and 39. At this time, the advertisement process is performed through channels 37 and 39 if channel 38 is masked and the advertisement process is performed through channel 37 if channels 38 and 39 are masked. At this time, of course, power required for transmission can be reduced as the number of used channels decreases. However, there is a trade-off relationship in which a probability of non-transmission of information due to interference increases.

If the environment in which the transmission device 20 is located is a communication environment with little interference, the number of channels to be used should be minimized by the channel mask and limited to the number of channels with the least probability of interference. Also, if the environment in which the transmission device 20 is located is a communication environment with a lot of interference, a large number of channels to be used should be used even at the expense of power consumption. Although the transmission device 20 cannot know the situation of the communication environment in advance, it is possible to select a suitable channel mask for adapting to the communication environment in which it is located and transmitting information with small power consumption according to “utilization” and “search” for the channel mask.

Here, as a simplified procedure, it is preferable to adjust the channel mask so that the number of channels for use in information communication increases when the deterioration rate D has increased. Also, when the deterioration rate D is regarded as sufficiently small, it is preferable to reduce power consumption by reducing the number of channels for use in communication. These are contradictory and it is preferable to appropriately update the channel mask in consideration of the trade-off between reliable transmission of information and power consumption in the algorithm 231.

As an example, the advertisement may accept a scan request. In this case, the central device, which has received the advertising packet, can transmit the scan request, and the deterioration rate D is calculated on the basis of whether or not the scan request has been answered. Also, when the transmission device 20 communicates with a plurality of reception devices 30, the deterioration rate D may be calculated on the basis of the number of advertising packets received by one or more specific reception devices 30.

### Transmission Time Interval and Transmission Count

Next, the first transmission interval SI1, the transmission count ST, and the second transmission interval SI2, which are examples of the communication parameter PM, will be described more specifically.

The first transmission interval SI1 is a time interval for transmitting the same data. This reduces the probability of interference by distributing the transmission of information (making the transmission of information redundant) in time. However, it is not practical to simply define the procedure for the deterioration rate and it is desirable to increase the time interval, for example, when continuous interference occurs during a relatively long period of time. On the other hand, when interference occurs frequently in bursts (in the form of condensation in a short time), it is desirable to shorten the time interval. Because it is difficult to estimate in advance a degree of interference dependent on the time of such a communication environment, the transmission device 20 derives a suitable communication parameter PM using “utilization” and “search.”

It is desirable to increase the transmission count ST when the deterioration rate D increases and to decrease the transmission count ST when the deterioration rate D is regarded as sufficiently small. This is to reduce the required power by reducing the transmission count ST.

When the first transmission interval SI1 and the transmission count ST are considered together, it is desirable to reduce a time period required to complete the transmission of the same data (a required transmission time period, for example, the product of the first transmission interval SI1 and the transmission count ST) in power reduction. This is because a control unit (a microcontroller, an integrated circuit, or another electronic circuit) (not shown) needs to continue an operation for the next transmission process during the required transmission time period and power is consumed as the required transmission time period increases.

Therefore, it is desirable to increase the required transmission time period when the deterioration rate D increases and to decrease the required transmission time period when the deterioration rate D is regarded as sufficiently small. Because the required transmission time period is defined by the first transmission interval SI1 and the transmission count ST, these values are independently adjusted in the algorithm 231.

The calculation unit 212 may adjust the communication parameter PM to reduce the first transmission interval SI1 when the reception device 30 has continuously and stably received the information transmitted by the wireless communication unit 22.

The second transmission interval SI2 is an interval for newly transmitting updated information. For example, when an information update frequency is not high, it is desirable to increase the second transmission interval SI2 when the deterioration rate D is regarded as sufficiently small. The second transmission interval SI2 also affects power consumption in a period from the start of operation of the device to the end of operation.

When it is estimated that the reception device 30, which is an information transmission target device, is not located within a communication range of the transmission device 20, it is desirable to increase the second transmission interval SI2 in order to prevent unnecessary information transmission from being frequently performed. This is, for example, the time when there is no communication even if all channels are used and the transmission power is sufficiently large or the like. In the case where the reception device 30 that is the other party of communication is restored, the number of channels and the transmission power should be maintained as they are, but the frequency of existence confirmation should be reduced.

The above-described time elements (the first transmission interval SI1, the transmission count ST, and the second transmission interval SI2) do not necessarily need to be used with values that exactly match numerical values decided on in the algorithm 231. For example, the numerical value decided on in the algorithm 231 may have a width of a certain extent and may be used as a communication interval. That is, the first transmission interval SI1, the transmission count ST, and the second transmission interval SI2 may be time intervals based on random values. For example, a time interval based on a random value may be implemented by adding a random value to the decided numerical value or subtracting a random value from the decided numerical value.

A method using a time interval based on a random value is useful for preventing mutual interference due to mutual matching of intervals when two or more devices use the method of the communication system 1. For example, when the transmission interval of device A is 400 [milliseconds (ms)] and the transmission interval of device B is also 400 [ms], interference may continue because the timings match. Even in such a case, interference can be avoided if the time interval is decided on the basis of a random value.

### Transmission Power

When the transmission power is included in the communication parameter PM, it is desirable to increase the strength of the radio waves when the deterioration rate D increases and to decrease the strength of the radio waves when the deterioration rate D is regarded as sufficiently small. This is to reduce the required power by adjusting the strength of radio waves by adapting to the communication environment.

Although a component provided in the transmission device 20 has been described as the communication parameter PM, the component provided in the reception device 30 may be used as a communication parameter. The component provided in the reception device 30 may be, for example, an ON duty ratio of the communication unit of the reception device 30, the number of stages of a multistage amplifier, a response speed of the response to the received packet, or the like.

### Modified Example of Communication History Information

FIG. 7 is a diagram showing a modified example of the communication history information according to the embodiment. The communication history information IHA will be described with reference to FIG. 7. The communication history information IHA is a modified example of the communication history information IH. Components similar to those of the communication history information IH are denoted by similar reference signs and description thereof may be omitted. The communication history information IHA further includes a parameter identifier PMID and has a channel mask CM, a first transmission interval SI1, a transmission count ST, a second transmission interval SI2, and power consumption PC as the communication parameter PM unlike the communication history information IH.

The communication history information IHA is stored in the communication history information storage unit 211 and the calculation unit 212 calculates the communication parameter PM on the basis of the communication history information IHA stored in the communication history information storage unit 211. The power consumption PC is power consumption generated by transmitting radio waves using the communication parameter PM included in the communication history information IHA. The deterioration rate D of the case where the communication parameter PM is used is associated with the communication history information IHA. That is, the calculation unit 212 calculates the communication parameter PM on the basis of the power consumption PC generated by transmitting radio waves using the communication parameter PM included in the communication history information IHA and the corresponding deterioration rate D. More specifically, the calculation unit 212 calculates the communication parameter PM to reduce the power consumption PC.

Because the communication history information IHA has a channel mask CM, a first transmission interval SI1, a transmission count ST, a second transmission interval SI2, and a power consumption PC as the communication parameter PM, the transmission device 20 can perform communication using a suitable communication parameter PM in consideration of the trade-off between communication reliability and power consumption with higher accuracy.

Here, because the communication history information IHA has a parameter identifier PMID, all combinations of values that can be taken by each communication parameter PM can be examined without omission. Also, because the communication history information IHA has a parameter identifier PMID, the algorithm 231 can easily find a suitable parameter.

### Summary of First Embodiment

According to the above-described embodiment, the transmission device 20 includes the state storage unit 251 to store the state information IC, includes the internal state storage unit 242 to store the internal state information ISI, includes the calculation unit 212 to calculate the communication parameter PM on the basis of the state information IC and the internal state information ISI, and includes the output unit 213 to output the calculated communication parameter PM. Therefore, according to the present embodiment, because the communication parameter PM is decided on the basis of the state information IC, it is possible to adapt to the communication environment at an early stage.

Also, according to the above-described embodiment, the calculation unit 212 includes a machine learning algorithm and the internal state information ISI includes learned parameters learned in the machine learning algorithm. Therefore, according to the present embodiment, by using machine learning, a suitable communication parameter PM can be decided on the basis of a plurality of input variables (a plurality of state information items of a communication result).

Also, according to the above-described embodiment, the machine learning algorithm is a reinforcement learning algorithm, and the internal state information ISI includes an action value function for use in the reinforcement learning algorithm. Therefore, according to the present embodiment, it is possible to iterate the search and utilization by oneself and decide on the communication parameter PM adapted to the environment at an early stage.

Also, according to the above-described embodiment, the state storage unit 251 stores a plurality of state information items IC acquired at a plurality of moments and the calculation unit 212 decides on the communication parameter PM on the basis of the plurality of state information items IC that have been accumulated. Therefore, according to the present embodiment, not only the current state but also the past state can be accumulated and utilized. Consequently, according to the present embodiment, a more suitable communication parameter PM can be decided on.

Also, according to the above-described embodiment, the transmission device 20 further includes a state information acquisition unit 252 for acquiring state information. Therefore, according to the present embodiment, the transmission device 20 can acquire information from a sensor provided inside or outside of the own device.

Also, according to the above-described embodiment, the state information IC is information indicating a time. Here, the communication situation may fluctuate depending on a time period. For example, the communication situation may be poor during a daytime period in which many people use radio waves and the communication situation may be good during a nighttime period in which many people do not use radio waves. According to the present embodiment, the transmission device 20 can adapt to a communication environment in which the communication situation fluctuates depending on the time period.

Also, according to the above-described embodiment, the state information IC is information indicating environmental information. Here, the communication situation may fluctuate depending on the surrounding environment. For example, on a rainy day and a sunny day, the number of people using radio waves may be different. According to the present embodiment, the transmission device 20 can adapt to a communication environment in which the communication situation fluctuates depending on the surrounding environment.

Also, according to the above-described embodiment, the state information IC is information indicating the position information of the own device. Here, the communication situation may fluctuate depending on the position of the own device. For example, the number of people using radio waves may be different between urban and rural areas. According to the present embodiment, the transmission device 20 can adapt to a communication environment in which the communication situation fluctuates depending on the position of the own device.

In addition, in the present embodiment, the position information is not limited to absolute position information and also includes relative position information such as the distance and positional relationship between target objects.

Also, according to the above-described embodiment, the position information is position coordinates acquired using a positioning system. Therefore, according to the present embodiment, the transmission device 20 can acquire position information or coordinate information from an externally provided positioning system.

Also, according to the above-described embodiment, the position information is estimated on the basis of both or one of the radio waves for acquiring the state information IC and the radio waves for performing information communication. Therefore, according to the present embodiment, position information can be acquired even in a building where GPS radio waves cannot be acquired. Also, according to the present embodiment, in addition to the position information estimated by a GPS device, the position information can be estimated more simply and in more detail to identify the position information with radio waves.

Also, according to the above-described embodiment, the calculation unit 212 estimates a congestion situation of radio waves around the own device from the state information IC stored in the state storage unit 251 and calculates the communication parameter PM on the basis of the estimated congestion situation. Therefore, according to the present embodiment, a state of crossed wires or lines of communication in the communication environment in which the transmission device 20 is located can be estimated and it is possible to quickly adapt to the communication environment in which the own device is located on the basis of the estimated state of crossed wires or lines of communication.

Also, according to the above-described embodiment, the calculation unit 212 estimates a density of people around the own device from the state information IC stored in the state storage unit 251 and calculates the communication parameter PM on the basis of the estimated density of people. Therefore, according to the present embodiment, a congestion situation of radio waves can be estimated on the basis of the density of the surrounding people and it is possible to adapt to the communication environment in which the own device is located at an early stage on the basis of the estimated congestion situation.

Also, according to the above-described embodiment, the state information IC is image information obtained by imaging the surroundings of the own device and the calculation unit 212 performs an estimation process based on the image information and calculates a communication parameter PM on the basis of an estimation result. Therefore, according to the present embodiment, the state of crossed wires or lines of communication is estimated from the number of people in a surrounding area and the like by estimating the congestion situation on the basis of the image acquired by the camera. According to the present embodiment, it is possible to adapt to the communication environment in which the own device is located at an early stage on the basis of the estimated state of crossed wires or lines of communication.

Also, according to the above-described embodiment, the state information IC is audio information collected around the own device and the calculation unit 212 performs an estimation process on the basis of the audio information and calculates the communication parameter PM on the basis of an estimation result. Therefore, according to the present embodiment, by estimating the congestion situation on the basis of the audio information acquired by the microphone, it is possible to estimate the state of crossed wires or lines of communication with a process with a small load, reduce the power consumption, and implement device miniaturization.

Also, according to the above-described embodiment, the state information IC is information indicating weather around the own device, and the calculation unit 212 calculates a communication parameter on the basis of information stored in the internal state storage unit 242 and corresponding to information indicating the weather indicated in the state information IC stored in the state storage unit 251. Therefore, according to the present embodiment, even if the communication system 1 performs communication in a communication method affected by the weather, the transmission device 20 can adapt to the environment.

Also, according to the above-described embodiment, the internal state storage unit 242 stores a plurality of internal state information items ISI and the calculation unit 212 calculates the communication parameter on the basis of the internal state information items ISI corresponding to the state information IC stored in the state storage unit 251 among the stored internal state information items ISI. That is, the calculation unit 212 refers to the internal state information ISI corresponding to the state information IC and decides on the communication parameter PM. Therefore, according to the present embodiment, the state information IC can be easily utilized in a simple process.

### Second Embodiment

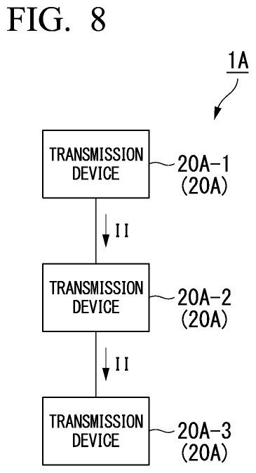

Next, the second embodiment will be described with reference to FIGS. 8 to 12. The communication system 1A in the second embodiment includes two or more transmission devices 20A. The transmission devices 20A are different from the transmission device 20 in that information communication is performed between the two or more transmission devices 20A. In the following description, information communication between the transmission devices 20A is also referred to as a “handover.”

First, the premise of the second embodiment will be described. The transmission device 20A according to the second embodiment is assumed to operate in a place where there is no stable external power supply. In the operation where there is no stable external power supply, when the battery lifespan is exhausted, the transmission device 20A cannot continue its operation and continues to be inoperable until the battery is charged or replaced.

Also, the battery of the transmission device 20A may be non-chargeable and disposable. When the battery of the transmission device 20A is disposable, the transmission device 20A is discarded at the end of the battery lifespan. However, sensing information obtained by the transmission device 20A is important, and an inoperable state may become a problem when it is not desirable to interrupt the transmission of data.

In this case, the transmission device 20A hands over its function to another standby transmission device 20A located in the vicinity of the own device.

FIG. 8 is a diagram for describing an example of the configuration of the communication system according to the second embodiment. The “handover” in the second embodiment will be described with reference to FIG. 8.

As examples of the transmission device 20A, the communication system 1A includes a transmission device 20A-1, a transmission device 20A-2, and a transmission device 20A-3. The transmission device 20A-1 transmits handover information II to the transmission device 20A-2. Also, the transmission device 20A-2 transmits the handover information II to the transmission device 20A-3. That is, the transmission device 20A-1 performs a handover to the transmission device 20A-2 and the transmission device 20A-2 performs a handover to the transmission device 20A-3.

Here, the handover information II is, for example, information including a learning result of the transmission device 20A. That is, according to the present embodiment, the information learned by the transmission device 20A-1 is handed over to the transmission device 20A-2. Therefore, according to the present embodiment, even if the transmission device 20A-1 becomes unusable due to a product lifespan or fault, the transmission device 20A-2 is replaced with the transmission device 20A-1 and therefore it is possible to continuously utilize the learned information. Likewise, even if the transmission device 20A-2 becomes unusable due to a product lifespan, a fault, or the like, the learned information can be continuously utilized by replacing the transmission device 20A-3 with the transmission device 20A-2.

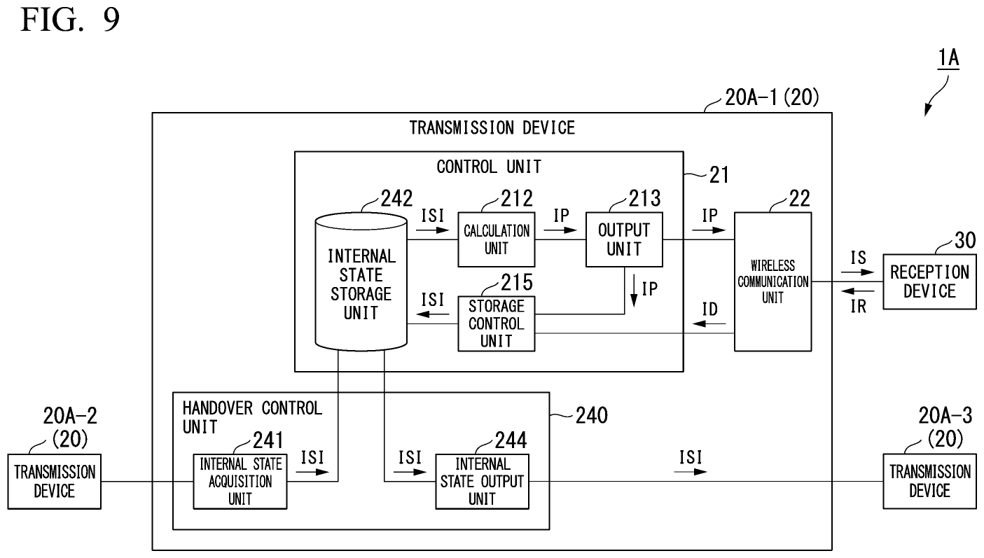

FIG. 9 is a block diagram showing an example of a functional configuration of the transmission device according to the second embodiment. An example of the functional configuration of the transmission device 20A will be described with reference to FIG. 9. In the description of the transmission device 20A, components similar to those of the transmission device 20 are denoted by similar reference signs and description thereof may be omitted. Unlike the transmission device 20, the transmission device 20A further includes a handover control unit 240.

The handover control unit 240 includes an internal state acquisition unit 241 and an internal state output unit 244. The handover control unit 240 controls the handover of the internal state information ISI between the transmission devices 20A.

In the example shown in FIG. 9, an example of the transmission device 20A-1 will be described. The transmission device 20A-1 receives the internal state information ISI handed over from the transmission device 20A-2 and hands over the internal state information ISI to the transmission device 20A-3. In the following description, the transmission device 20A-2 is also referred to as a first device and the transmission device 20A-3 is also referred to as a second device.

The internal state acquisition unit 241 acquires internal state information ISI indicating the internal state of the first device from the transmission device (first device) 20A-2, which is a device separate from itself. The internal state acquisition unit 241 causes the internal state storage unit 242 to store the acquired internal state information ISI. That is, the internal state storage unit 242 stores the internal state information ISI acquired by the internal state acquisition unit 241.

Here, the device separate from itself refers to an independent device that performs mutual communication. Therefore, another individual of the same standard is also the device separate from itself.

The calculation unit 212 performs a process based on the internal state information ISI stored in the internal state storage unit 242. The process based on the internal state information ISI may be, for example, a process of calculating the communication parameter PM for performing information communication on the basis of the internal state information ISI. As a result of performing the process, the calculation unit 212 updates the internal state information ISI stored in the internal state storage unit 242. That is, the internal state information ISI stored in the internal state storage unit 242 is updated on the basis of the process performed by the calculation unit 212.

The internal state output unit 244 outputs the internal state information ISI stored in the internal state storage unit 242 at a predetermined handover timing. Specifically, the internal state output unit 244 outputs the internal state information ISI to the transmission device (second device) 20A-3, which is a device separate from the transmission device (first device) 20A-2.

In addition, at the time of the handover, some functions of a handover destination device may be in a dormant state. Some functions in the dormant state may be, for example, functions that are not involved in the handover function of the calculation unit 212 or the like. That is, at the time when the internal state acquisition unit 241 acquires the internal state information ISI, the calculation unit 212 is in the dormant state, and the internal state acquisition unit 241 and the internal state output unit 244 are not in the dormant state.

### First Modified Example of Second Embodiment

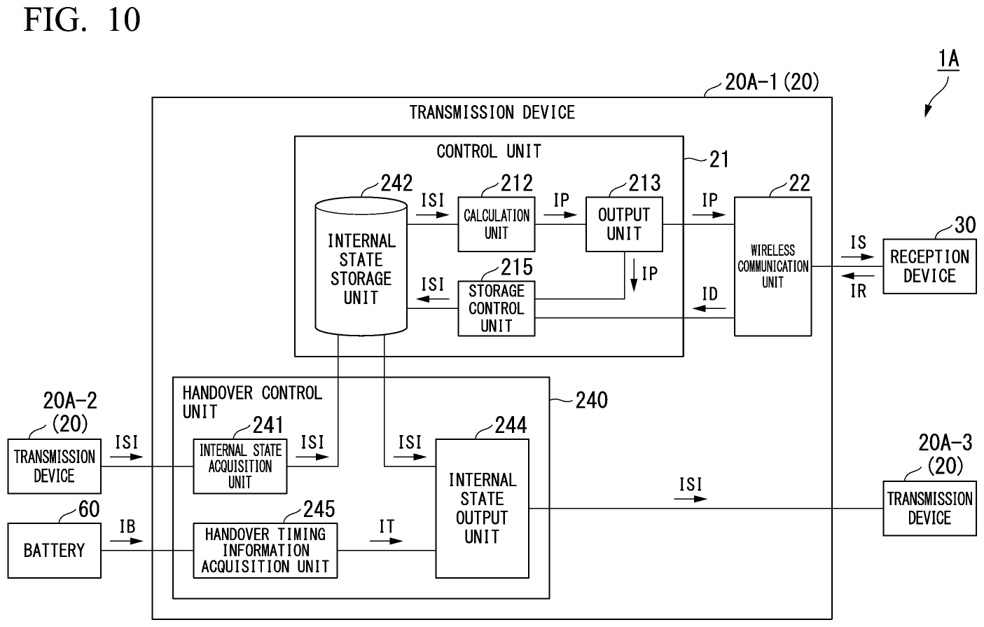

FIG. 10 is a block diagram showing a first modified example of the functional configuration of the transmission device according to the second embodiment. The first modified example of the transmission device 20A will be described with reference to FIG. 10. Unlike the above-described transmission device 20A, the first modified example of the transmission device 20A includes a handover timing information acquisition unit 245.

The handover timing information acquisition unit 245 acquires handover timing information IT. The handover timing information IT includes information about a handover timing, which is a timing serving as a trigger for performing the handover. The internal state output unit 244 outputs the internal state information ISI on the basis of information about the handover timing included in the acquired handover timing information IT.

For example, the handover timing information acquisition unit 245 may acquire information about a battery level of the battery 60, which is a power supply that drives the own device, as the handover timing information IT. The information about the battery level of the battery 60 may be a power supply voltage.

The internal state output unit outputs the internal state information ISI when the battery level of the battery 60 included in the acquired handover timing information IT falls below a predetermined threshold value. When the information about the battery level of the battery 60 is a power supply voltage, the internal state output unit outputs the internal state information ISI when the power supply voltage falls below a predetermined threshold value.

In addition, the transmission device 20A may perform the handover on the basis of a predetermined cycle. In this case, the handover timing information IT may include information about the predetermined cycle.

The internal state output unit outputs the internal state information at the predetermined cycle included in the acquired handover timing information.

### Second Modified Example of Second Embodiment

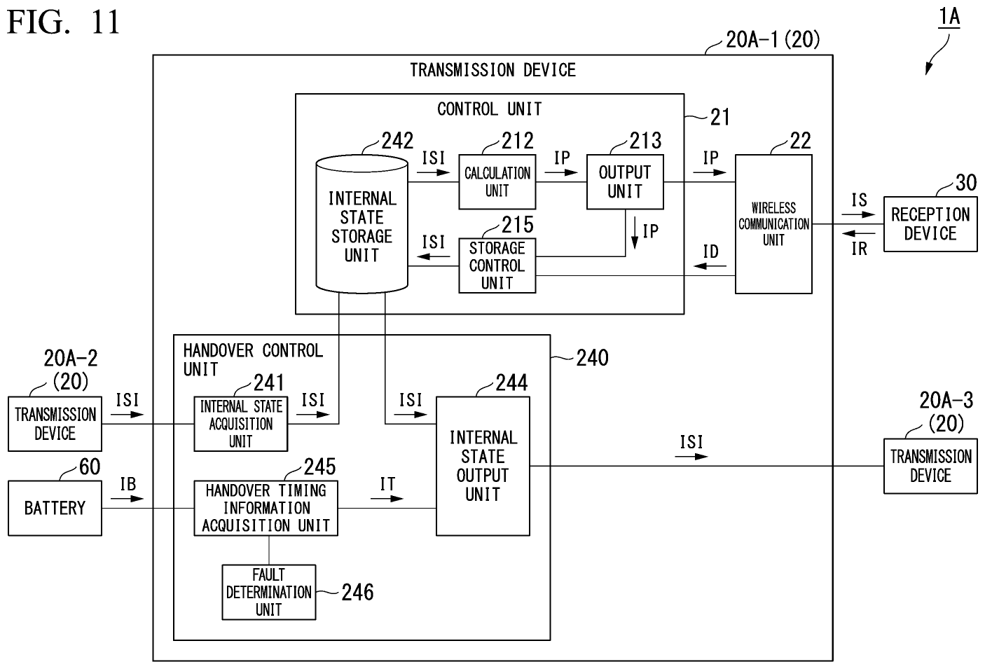

FIG. 11 is a block diagram showing a second modified example of the functional configuration of the transmission device according to the second embodiment. The second modified example of the transmission device 20A will be described with reference to FIG. 11. Unlike the first modified example of the transmission device 20A described above, the second modified example of the transmission device 20A includes a fault determination unit 246.

The fault determination unit 246 determines whether or not the own device is in a fault state. The fault determination unit 246 outputs information about whether or not the own device is in the fault state to the handover timing information acquisition unit 245. The handover timing information acquisition unit 245 acquires a determination result of the fault determination unit 246 as the handover timing information IT. The internal state output unit 244 outputs the internal state information ISI when the own device is in the fault state.

In addition, the fault determination unit 246 may be a watchdog timer (WDT) controlled by the calculation unit 212 or the like.

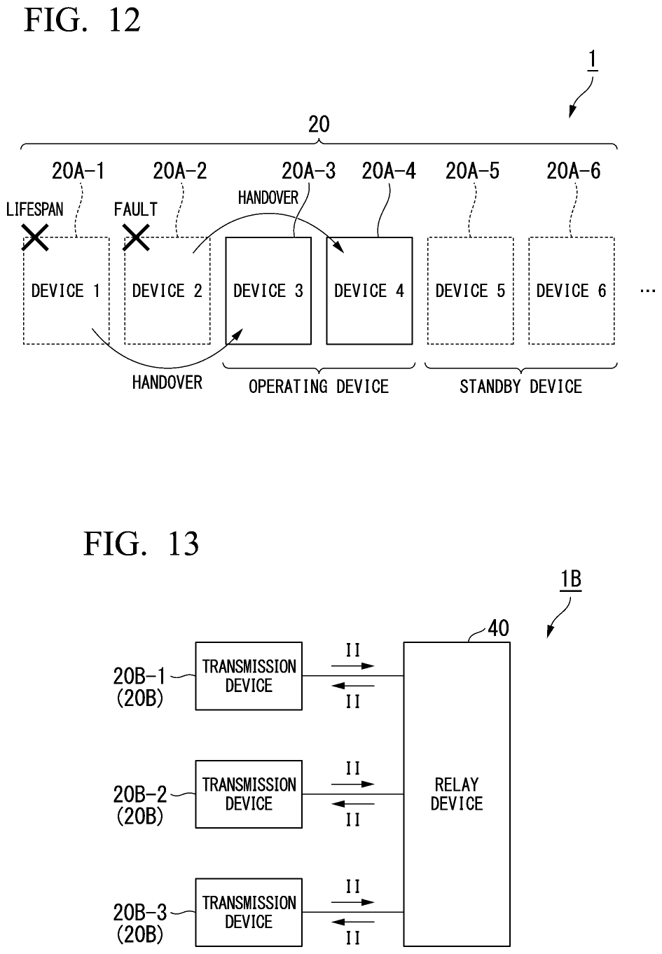

FIG. 12 is a diagram for describing the handover between transmission devices according to the second embodiment. The handover between the transmission devices 20A will be described with reference to FIG. 12. In an example shown in FIG. 12, the transmission device 20A is a sensor node constituting a wireless sensor network. The transmission device 20A may be referred to as a sensor node.

In an example shown in FIG. 12, six transmission devices 20A, i.e., transmission devices 20A-1 to 20A-6, are shown. The transmission device 20A-1 cannot be used due to its lifespan and the transmission device 20A-2 is in a state in which it cannot be used due to a fault. The transmission device 20A-3 and the transmission device 20A-4 are in an operating state and the transmission device 20A-5 and the transmission device 20A-4 are in a standby state (a dormant state).

Here, the transmission device 20A-3 receives the internal state

information ISI in a handover process when the transmission device 20A-1 cannot be continuously used due to its lifespan. Also, the transmission device 20A-4 receives the internal state information ISI in a handover process when the transmission device 20A-2 stops the operation due to a fault.

Here, when the sensor nodes are installed at a plurality of locations over a wide area, it may not be necessary to operate all the sensor nodes at the same time. Therefore, in the example shown in FIG. 12, the transmission device 20A-3 and the transmission device 20A-4 are in an operating state and the transmission device 20A-5 and the transmission device 20A-6 are in a standby state. In this case, the transmission device 20A-5 and the transmission device 20A-6 in the standby state wait in a dormant state and play a role as a spare sensor node.

When one of the sensor nodes falls into an inoperable state, the sensor node (which hereinafter may be referred to as a handover source node) hands over a function of a sensor node as the internal state information ISI to another sensor node (which hereinafter may be referred to as a handover destination node). At this time, in the handover process, the handover destination node is in an operating state and the sensor function, the communication function, and the like are valid.

It is important for the handover destination node to collect sensor information in an environment similar to that of the handover source node. Therefore, in order to hand over the function of a sensor node, the handover destination node should be naturally located in the vicinity of the handover source node. That is, the handover source node and the handover destination node operate in a similar communication environment. Examples of a similar communication environment include a close installation distance, the use of the same communication network, and the like.

According to the present embodiment, because the information accumulated as a sensor node is handed over, there is no need to start new learning from scratch due to the loss of the learned information. That is, because the learned information can be shared between the handover source node and the handover destination node, it is possible to adapt to the communication environment immediately after the handover.

Here, the handover timing will be described. In the example described with reference to FIG. 12, an example in which the transmission device 20A-1 performs a handover at a timing when it becomes unusable due to its lifespan and the transmission device 20A-2 performs a handover at a timing when it becomes unusable due to a fault has been described. However, the handover timing is not limited to these examples and the handover may be performed, for example, before it is determined that the device becomes unusable.

When the handover is performed before it is determined that the device becomes unusable, the latest information may be handed over by performing the handover multiple times between the same handover source node and the handover destination node(s). A plurality of handovers are equivalent to periodically backing up the internal state information ISI. Therefore, regular backup can prevent the unexpected loss of the internal state information ISI.

Also, in such a case where it may be necessary to increase the number of operating nodes on demand for the actual use of the sensor network, the handover may also be performed.

Next, the handover destination node will be described. In an example described with reference to FIG. 12, an example in which the transmission device 20A-1 performs a handover to the transmission device 20A-3 and the transmission device 20A-2 performs a handover to the transmission device 20A-4 has been described. However, the handover destination node is not limited to an example in the case of one device as in these examples and a handover to a plurality of handover destination nodes may be performed.

Further, any communication function may be used for the handover, the handover may be performed via a communication function of the internal state output unit 244, the handover may be performed via a communication function of the wireless communication unit 22, or the handover may be another communication function. It does not matter whether communication for the handover is wireless or wired communication.

### Summary of Second Embodiment

According to the above-described embodiment, the transmission device 20A includes the internal state acquisition unit 241 to acquire the internal state information ISI from a device separate from itself, includes the internal state storage unit 242 to store the acquired internal state information ISI, includes the calculation unit 212 to perform a process based on the stored internal state information ISI, and includes the internal state output unit 244 to output the internal state information ISI at a predetermined handover timing.

Therefore, according to the present embodiment, even if the transmission device 20A unintentionally becomes inoperable, the internal state information ISI can be handed over to a successor. Therefore, according to the present embodiment, it is not necessary to learn from scratch anew and it is possible to use a learning result of a predecessor.

Therefore, according to the present embodiment, even if the transmission device 20A is replaced, the use of the transmission device 20A of the successor can be started immediately.

Also, according to the above-described embodiment, the internal state information ISI is updated on the basis of the process performed by the calculation unit 212. The calculation unit 212 calculates the communication parameter PM on the basis of the internal state information ISI. That is, the internal state information ISI is updated on the basis of the communication parameter PM. Therefore, the internal state information ISI is updated on the basis of a signal communication result according to an environment in which the own device is located.

Therefore, according to the present embodiment, because the internal state information ISI updated on the basis of the signal communication result according to the environment in which the own device is located is handed over, it is possible to hand over the learning result over time.

Also, according to the above-described embodiment, the calculation unit 212 includes a machine learning algorithm and the internal state information ISI includes learned parameters learned in the machine learning algorithm. Therefore, according to the present embodiment, the learned parameters updated in the algorithm using machine learning can be handed over and the learned parameters can be prevented from being lost when the own device is unintentionally inoperable.

Also, according to the above-described embodiment, the machine learning algorithm is a reinforcement learning algorithm and the internal state information ISI includes an action value function for use in the reinforcement learning algorithm. Therefore, according to the present embodiment, the action value function updated in the algorithm using reinforcement learning can be handed over and the action value function can be prevented from being lost when the own device is unintentionally inoperable. Consequently, the transmission device 20A, which is the handover destination node, can resume a process in a state in which reinforcement learning has progressed.

Also, according to the above-described embodiment, the calculation unit 212 calculates the communication parameter PM for performing information communication on the basis of the internal state information ISI. The transmission device 20A includes a wireless communication unit 22 to perform information communication according to the communication parameter PM calculated by the calculation unit 212. Therefore, according to the present embodiment, even if the transmission device 20A is in an inoperable state for some reason, a learning result of the transmission device 20A can be handed over to another device. Consequently, the transmission device 20A, which is the handover destination node, can resume a process in a state in which it is adapted to the communication environment.

Also, according to the above-described embodiment, the transmission device 20A includes a handover timing information acquisition unit 245 to acquire handover timing information IT including information about a handover timing. Also, the internal state output unit 244 outputs internal state information on the basis of information about the handover timing included in the acquired handover timing information IT. Therefore, the transmission device 20A can output internal state information ISI at a suitable handover timing.

Also, according to the above-described embodiment, the handover timing information acquisition unit 245 acquires information about a battery level of the battery 60, which is a power supply that drives the own device, as the handover timing information IS. Also, the internal state output unit 244 outputs the internal state information ISI when the battery level of the battery 60 falls below a predetermined threshold value. Therefore, the transmission device 20A can hand over the internal state information ISI to the successor before the function is completely stopped. Therefore, when there is only one battery in the transmission device 20A or the like, it is possible to prevent a situation in which the handover itself becomes impossible due to insufficient battery power.

Also, according to the above-described embodiment, the transmission device 20A includes a fault determination unit 246 to determine whether or not the own device is in a fault state. Also, the handover timing information acquisition unit 245 acquires a determination result of the fault determination unit 246 as the handover timing information IT and the internal state output unit 244 outputs the internal state information ISI when the own device is in a fault state. Therefore, the transmission device 20A can perform a handover when the process cannot be continued. That is, the transmission device 20A can hand over the internal state to the successor when the function is stopped. In other words, the transmission device 20A can perform the handover when it is determined that the process can no longer be continued even for reasons other than power shutoff.

Also, according to the above-described embodiment, the handover timing information IT includes information about a predetermined cycle and the internal state output unit 244 outputs the internal state information ISI at a predetermined cycle included in the acquired handover timing information IT. Therefore, the transmission device 20A, which is the handover source node, periodically outputs the internal state information ISI to the handover destination node, such that even if it falls into a situation where the handover is not possible, the process can be resumed on the basis of the internal state information ISI that has already been handed over.

Also, according to the above-described embodiment, at a point in time when the internal state acquisition unit 241 has acquired the internal state information ISI, the calculation unit 212 is in a dormant state and the internal state acquisition unit 241 and the internal state output unit 244 are not in the dormant state. Therefore, according to the present embodiment, by setting the transmission device 20A, which is the handover destination node, in the dormant state, it can be installed as a spare machine without consuming power of some sensor nodes constituting the sensor network and the function can be handed over to the standby device when the function of the device in operation stops.

### Third Embodiment

Next, a third embodiment will be described with reference to FIGS. 13 to 17. Unlike the communication system 1A, the communication system 1B in the third embodiment includes a transmission device 20B instead of the transmission device 20A. Also, the communication system 1B includes a relay device 40 in addition to the transmission device 20B. Unlike the transmission device 20A, the transmission device 20B performs a handover to the relay device 40 and receives a handover from the relay device 40 in place of or in addition to a process of performing a handover between the transmission devices 20A in the communication system 1A. In the description of the transmission device 20B, components similar to those of the transmission device 20A are denoted by similar reference signs and description thereof may be omitted.

FIG. 13 is a diagram for describing an example of the configuration of the communication system according to the second embodiment. The transmission device 20B will be described with reference to FIG. 13. The transmission device 20B according to the third embodiment is connected directly to the relay device 40 or via a predetermined network. The predetermined network may be a cloud system.

The transmission device 20B transmits handover information II to the relay device 40 and acquires the handover information II from the relay device 40. The handover information II may include internal state information ISI.

When the handover information II is acquired from the transmission device 20B, the relay device 40 stores the internal state information ISI included in the acquired handover information II in the storage unit. The relay device 40 outputs the handover information II to the transmission device 20B at a predetermined handover timing or when the transmission device 20B becomes inoperable.

That is, the relay device 40 stores the internal state information ISI of the transmission device 20B and the internal state information ISI of the handover source node held by the relay device 40 can be handed over to the new handover destination node when the transmission device 20B becomes inoperable for some reason and cannot perform a handover. As a result, the handover destination node can continue a process after the internal state information ISI of the handover source node is handed over instead of from the complete initial state.

Also, when the transmission device 20B is a sensor node constituting a sensor network, the sensor node may periodically transmit the internal state to other sensor nodes and replicate the internal state. For example, the internal state is periodically transmitted to other sensor nodes and the replicated internal state may be handed over even if it becomes impossible to perform the handover for some reason.

Specifically, a sensor node of a replication destination may be, for example, a sensor node serving as a future handover destination. In this case, the sensor node serving as the future handover destination is in a dormant state, but only the internal state of a replication source is held. When a sensor node of the replication source becomes inoperable, the sensor node serving as the future handover destination starts the operation and starts operating from the time of the replicated internal state. Replication may be performed via the relay device 40.

Also, the relay device 40 itself may store the replicated internal state information ISI. When the sensor node of the replication source becomes inoperable, the relay device 40 performs a handover to the sensor node serving as the future handover destination instead of the sensor node of the replication source. The sensor node of the future handover destination starts an operation on the basis of the internal state information ISI handed over from the relay device 40. By making such a configuration, the handover destination node can be used immediately and the standby power can be further reduced.

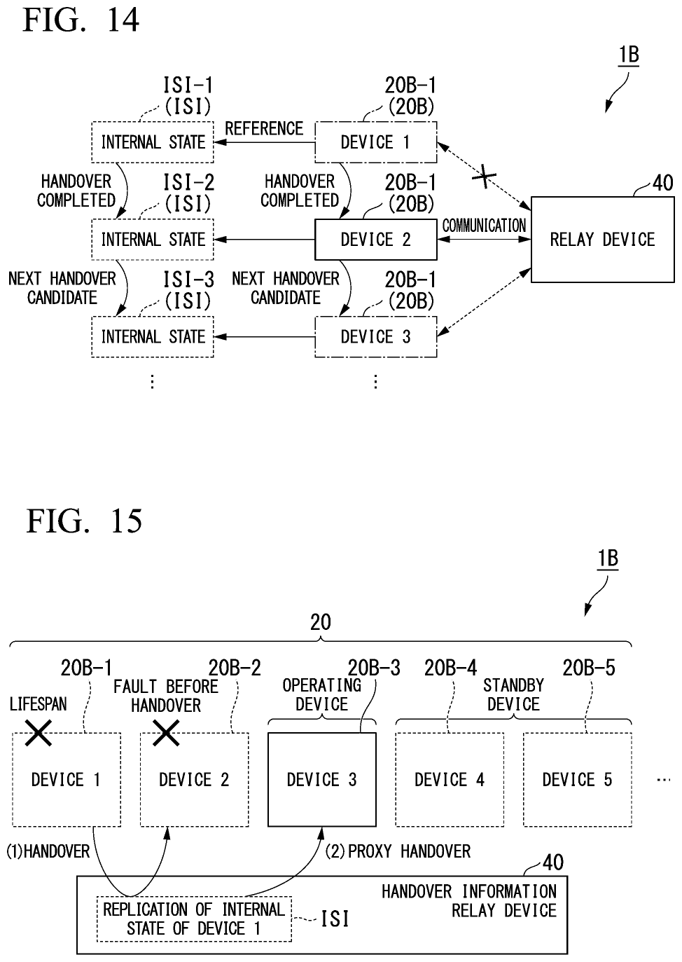

FIG. 14 is a diagram for describing a handover in the case where the relay device according to the third embodiment performs a relay process. An example of a handover in which the relay device 40 performs the relay process will be described with reference to FIG. 14.

In an example shown in FIG. 14, each of the transmission device 20B-1, the transmission device 20B-2, and the transmission device 20B-3 performs a handover through the relay process of the relay device 40. The transmission device 20B-1 is in a state in which it cannot be used due to its lifespan or other reasons. The transmission device 20B-2 is in an operating state and the transmission device 20B-3 is in a standby state (dormant state). Here, the transmission device 20B-2 receives the internal state information ISI handed over from the relay device 40 when the transmission device 20B-1 can no longer be used continuously due to its lifespan or other reasons. Also, because the transmission device 20B-3 is in a standby state but is the next handover candidate, the transmission device 20B-3 receives the internal state information ISI of the transmission device 20B-2 handed over through the relay process of the relay device 40.

FIG. 15 is a diagram for describing a proxy handover in a case where the relay device according to the third embodiment performs a relay process. The proxy handover will be described with reference to FIG. 15. In an example described with reference to FIG. 15, the transmission device 20B is a sensor node constituting a sensor network.

The sensor node periodically performs survival confirmation communication with the relay device 40. The relay device 40 can ascertain the operating state of the sensor node constituting the sensor network by acquiring periodic survival confirmation communication from the sensor node.

Specifically, the communication system 1B, which is a sensor network, includes transmission devices 20B-1 to 20B-5 and a relay device 40. The transmission device 20B-1 cannot be used due to its lifespan and the transmission device 20B-2 is in a state in which it cannot be used due to a fault. The transmission device 20B-3 is in an operating state and the transmission device 20B-4 and the transmission device 20B-5 are in a standby state (dormant state).

Here, the transmission device 20B-2 receives the internal state information ISI handed over through a relay process of the relay device 40 when the transmission device 20B-1 cannot be used continuously due to its lifespan. However, because the transmission device 20B-2 has stopped an operation due to a fault before the handover, the internal state information ISI cannot be handed over to the successor.

Therefore, according to the present embodiment, the relay device 40 performs the proxy handover to the transmission device 20B-3 instead of the transmission device 20B-2. According to a configuration in this way, it is possible to prevent the loss of information of the internal state information ISI handed over from the transmission device 20B-1.

In the present embodiment, because the relay device 40 can ascertain the operating state of the sensor node constituting the sensor network, it is possible to perform a proxy handover for the sensor node that has become inoperable due to a fault or the like.

For example, when the survival confirmation communication from the sensor node has been interrupted, the relay device 40 determines that the sensor node has become inoperable and performs a handover to another sensor node.

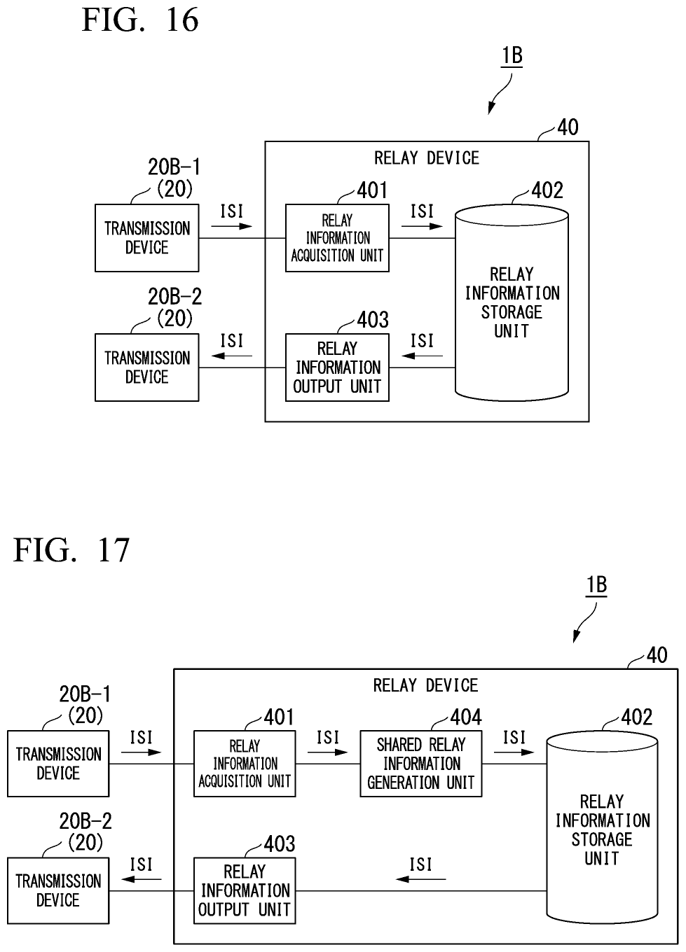

FIG. 16 is a block diagram showing an example of the functional configuration of the relay device according to the third embodiment. A functional configuration of the relay device 40 will be described with reference to FIG. 16.

The communication system 1B according to the third embodiment includes a plurality of transmission devices 20B and a relay device 40. Specifically, a transmission device 20B-1 and a transmission device 20B-2 are included as transmission devices 20B.

The relay device 40 transmits and receives internal state information ISI to and from one or more transmission devices 20B. Specifically, the relay device 40 acquires the internal state information ISI from the transmission device 20B-1, stores the acquired internal state information ISI, and outputs the stored internal state information ISI to the transmission device 20B-2.

The relay device 40 includes a relay information acquisition unit 401, a relay information storage unit 402, and a relay information output unit 403.

The relay information acquisition unit 401 acquires the internal state information ISI output by the transmission device 20B as relay information. The relay information storage unit 402 stores relay information acquired by the relay information acquisition unit 401. The relay information output unit 403 outputs the relay information stored in the relay information storage unit 402 as the internal state information ISI to the transmission device 20B.

In addition, when the relay device 40 is configured to perform a handover to another sensor node when the survival confirmation communication from the sensor node has been interrupted, the internal state output unit 244 provided in the transmission device 20B outputs the internal state information ISI to the relay device 40 on the basis of a predetermined cycle. Also, the relay information output unit 403 provided in the relay device 40 outputs relay information to the transmission device 20B, which is a handover destination node, when the relay information acquisition unit 401 has failed to acquire internal state information ISI from the transmission device 20B for a predetermined period or more.

FIG. 17 is a block diagram showing a modified example of the functional configuration of the relay device according to the third embodiment. A modified example of the relay device 40 will be described with reference to FIG. 17.

In the present embodiment, the relay device 40 accumulates internal states of a plurality of transmission devices 20B in the relay device 40. The internal states accumulated in the relay device 40 are integrated and utilized at the time of the handover to the other transmission device 20B.

In the present embodiment, the relay device 40 includes a shared relay information generation unit 404.

The shared relay information generation unit 404 generates shared relay information on the basis of the relay information acquired from the plurality of transmission devices 20B. In this case, the relay information storage unit 402 stores the shared relay information as the relay information. Also, the relay information output unit 403 outputs the shared relay information as the relay information.

In addition, the shared relay information generation unit 404 may generate the shared relay information, for example, using the acquisition of relay information by the relay information acquisition unit 401 as a trigger. That is, the shared relay information may be generated when a handover process is performed.

In the present embodiment, the relay device 40 can contribute to the early application of the other transmission device 20B by integrating the internal states of the plurality of transmission devices 20B. For example, when the sensor network is widely spread and the sensor nodes are scattered over a wide area, the configuration in the present embodiment is effective. The transmission device 20B outputs self-learned content associated with the environment information and an internal state in which each sensor node is installed to the relay device 40 at the time of the handover.

At this time, a sensor node A in operation and a newly installed sensor node B are at locations away from each other, but are installed in similar environments. The sensor node B hands over information learned by the sensor node A through the relay device 40. Because the sensor node B can be seen to have an environment similar to that of the sensor node A according to a value measured by an on-board sensor, the internal state of the sensor node A is preferentially adopted among the internal states that have been handed over and the early adaptation to the environment in which the sensor node B is located is possible. When a plurality of sensor nodes, especially a large-scale network, can be constructed, sharing the internal state by accumulating such shared relay information is an effective means.

### Summary of Third Embodiment

According to the above-described embodiment, the communication system 1B includes a plurality of transmission devices 20B and a relay device 40. The relay device 40 includes a relay information acquisition unit 401 to acquire internal state information ISI from the transmission device 20B, includes a relay information storage unit 402 to store the acquired internal state information ISI, and includes a relay information output unit 403 to output the stored internal state information ISI to the transmission device 20B. Therefore, in the communication system 1B according to the present embodiment, the transmission device 20B can perform a handover via the relay device 40.

According to the present embodiment, because it is possible to perform a handover via the relay device 40, it is possible to prevent the learning result from being lost even if the handover cannot be performed between the transmission devices 20B.

Also, according to the above-described embodiment, because it is possible to perform a handover via the relay device 40, the battery level and abnormalities of each transmission device 20B can be monitored by the relay device 40 and the appropriate handover timing can be controlled.

Also, according to the above-described embodiment, the internal state output unit 244 provided in the transmission device 20B outputs the internal state information ISI to the relay device on the basis of a predetermined cycle and the relay information output unit 403 provided in the relay device 40 outputs relay information when the relay information acquisition unit 401 has not acquired the internal state information ISI from the transmission device 20B for a predetermined period of time or more. Therefore, according to the present embodiment, the relay device 40 can hand over the internal state information ISI to the successor even though the function is stopped by performing a handover even if the function cannot be continued due to the power supply of the transmission device 20B being cut off or the like.

Also, according to the above-described embodiment, the relay device 40 generates shared relay information on the basis of relay information acquired from a plurality of transmission devices 20B by sparsely disconnecting the shared relay information generation unit 404. Therefore, according to the present embodiment, the transmission device 20B of a new handover destination can perform early learning by integrating or processing the internal states obtained from the plurality of transmission devices 20B.

Also, according to the above-described embodiment, the shared relay information is generated using the acquisition of the relay information by the relay information acquisition unit 401 as a trigger. That is, the shared relay information is generated when the handover process is performed. Therefore, according to the present embodiment, the internal state can be accumulated in the relay device 40 without generating an extra communication process by accumulating the internal state at the time of the handover.

Also, the above-described first and second embodiments can be used in combination. For example, in the transmission device 20 according to the first embodiment, the internal state storage unit 242 may store the acquired internal state information ISI. In this case, the transmission device 20 further includes an internal state acquisition unit to acquire information indicating the internal state of the transmission device 20 different from itself as the internal state information ISI. The calculation unit 212 calculates the communication parameter PM on the basis of the internal state information ISI stored in the internal state storage unit 242.

That is, the transmission device 20 according to the first embodiment can also receive the internal state handed over from the other transmission device 20. Therefore, according to the present embodiment, a spare transmission device 20 is provided, such that the function can be handed over from the spare transmission device 20 even if one of the transmission devices 20 is in an inoperable state and the reliability of the communication system 1 as a whole can be improved.

Also, the transmission device 20 according to the first embodiment may further include an internal state output unit to output the internal state information ISI stored in the internal state storage unit 242 at a predetermined handover timing. That is, according to the present embodiment, a spare transmission device 20 is provided, such that the function can be handed over to the spare transmission device 20 even if one transmission device 20 is in an inoperable state and the reliability of the communication system 1 as a whole can be improved.

Also, the communication system 1 according to the first embodiment may include a relay device 40. The relay device 40 transmits and receives internal state information ISI to and from one or more transmission devices 20. Also, the relay device 40 includes a relay information acquisition unit 401 to acquire the internal state information ISI as relay information, includes a relay information storage unit 402 to store the acquired relay information, and includes a relay information output unit 403 to output the stored relay information as the internal state information ISI. Therefore, according to the present embodiment, the transmission device 20 can perform a handover via the relay device 40.

Also, in the communication system 1 according to the first embodiment, the relay device 40 may include a shared relay information generation unit 404. The shared relay information generation unit 404 generates shared relay information on the basis of the relay information acquired from the plurality of transmission devices 20. The relay information storage unit 402 stores the shared relay information as relay information and the relay information output unit 403 outputs the shared relay information as the relay information. Therefore, according to the present embodiment, the transmission device 20 of a new handover destination can perform early learning by integrating or processing the internal states obtained from the plurality of transmission devices 20.

Also, the transmission device 20A according to the second embodiment may further include a state storage unit 251 to store state information IC. In this case, the internal state storage unit 242 stores information for use in calculation of the communication parameter PM and the state information IC as the internal state information ISI in association. Also, the calculation unit 212 calculates the communication parameter PM on the basis of the state information IC stored in the state storage unit 251 and the internal state information ISI stored in the internal state storage unit 242. Therefore, according to the present embodiment, because the communication parameter PM is decided on the basis of the state information IC, it is possible to adapt to the communication environment at an early stage.

Also, in the transmission device 20A according to the second embodiment, the state storage unit 251 stores a plurality of state information items IC acquired at a plurality of moments and the calculation unit 212 decides on the communication parameter PM on the basis of the plurality of state information items IC that have been accumulated. Therefore, according to the present embodiment, not only the current state but also the past state can be accumulated and utilized. Consequently, according to the present embodiment, a more suitable communication parameter PM can be decided on.

Although an example in which the transmission device 20, the reception device 30, and the relay device 40 perform information communication based on wireless communication has been described above, the present embodiment is not limited to an example of wireless communication. The transmission device 20, the reception device 30, and the relay device 40 may perform information communication based on wired communication. When the transmission device 20, the reception device 30, and the relay device 40 perform information communication based on wired communication, the channel may be included as a communication parameter if the communication interval, the transmission power, and the communication are multiplexed.

In this case, it is possible to transmit information with minimal power consumption while avoiding interference from other devices connected by the same line. An example of the wired communication may be an integral or many-to-many wired communication method such as a bus connection, a star connection, or a mesh connection. Specifically, it may be a communication method such as the Internet, an inter-integrated circuit (I2C), a serial peripheral interface (SPI), a controller area network (CAN), or the like.

All or some functions provided in the devices provided in the communication system 1 according to the above-described embodiment and the parts provided in the devices are implemented by recording a program for implementing these functions on a computer-readable recording medium and causing a computer system to read and execute the program recorded on the recording medium. Also, the “computer system” used herein is assumed to include an operating system (OS) and hardware such as peripheral equipment.

Also, the “computer-readable recording medium” refers to a flexible disk, a magneto-optical disc, a read-only memory (ROM), a portable medium such as a compact disc (CD)-ROM, or a storage device such as a hard disk embedded in the computer system. Furthermore, the “computer-readable recording medium” may include a computer-readable recording medium for dynamically holding the program for a short time period as in a communication line when the program is transmitted via a network such as the Internet or a communication circuit such as a telephone circuit and a computer-readable recording medium for holding the program for a given time period as in a volatile memory inside the computer system serving as a server or a client when the program is transmitted. Also, the above-described program may be a program for implementing some of the above-described functions. Furthermore, the above-described program may be a program capable of implementing the above-described function in combination with a program already recorded on the computer system.

Although embodiments of the present invention have been described above, the present invention is not limited to the embodiments and various modifications can also be made without departing from the scope and spirit of the present invention.

### INDUSTRIAL APPLICABILITY

According to the present invention, a transmission device can hand over a learning result to another device when the transmission device is replaced with the other device.

### REFERENCE SIGNS LIST

1 Communication system
10 Communication device
20 Transmission device
30 Reception device
21 Control unit
211 Communication history information storage unit
212 Calculation unit
213 Output unit
215 Storage control unit
22 Wireless communication unit
221 Antenna
231 Algorithm
232 Guideline information
233 Communication history information
31 Control unit
32 Wireless communication unit
321 Antenna
240 Handover control unit
241 Internal state acquisition unit
242 Internal state storage unit
243 Processing unit
244 Internal state output unit
245 Handover timing information acquisition unit
246 Fault determination unit
40 Relay device
401 Relay information acquisition unit
402 Relay information storage unit
403 Relay information output unit
404 Shared relay information generation unit
251 State storage unit
252 State information acquisition unit
50 State information acquisition device
60 Battery
IS Transmission information
IR Reception information
IH Communication history information
IP Parameter information
ISI Internal state information
ID Deterioration information
II Handover information
IC State information
IT Handover timing information
PM Communication parameter
D Deterioration rate
SI1 First transmission interval
SI2 Second transmission interval
ST Transmission count

1. A communication device comprising:
an internal state acquisition unit configured to acquire internal state information indicating an internal state of a first device from the first device, which is a device separate from the communication device;
an internal state storage unit configured to store the acquired internal state information;
a calculation unit configured to perform a process based on the stored internal state information; and
an internal state output unit configured to output the internal state information stored in the internal state storage unit to a second device, which is a device separate from the first device, at a predetermined handover timing.

2. The communication device according to claim 1, wherein the internal state information stored in the internal state storage unit is updated on the basis of a process performed by the calculation unit.

3. The communication device according to claim 1,
wherein the calculation unit includes a machine learning algorithm, and
wherein the internal state information includes a learned parameter learned in the machine learning algorithm.

4. The communication device according to claim 3,
wherein the machine learning algorithm is a reinforcement learning algorithm, and
wherein the internal state information includes an action value function for use in the reinforcement learning algorithm.

5. The communication device according to claim 1,
wherein the calculation unit calculates a communication parameter for performing information communication on the basis of the internal state information stored in the internal state storage unit, and
wherein the communication device further comprises a wireless communication unit configured to perform the information communication corresponding to the communication parameter calculated by the calculation unit.

6. The communication device according to claim 1, further comprising a handover timing information acquisition unit configured to acquire handover timing information including information about the handover timing,
wherein the internal state output unit outputs the internal state information on the basis of the information about the handover timing included in the acquired handover timing information.

7. The communication device according to claim 6,
wherein the handover timing information acquisition unit acquires information about a battery level of a power supply for driving the communication device as the handover timing information, and
wherein the internal state output unit outputs the internal state information when the battery level is less than a predetermined threshold value.

8. The communication device according to claim 6, further comprising a fault determination unit configured to determine whether or not the communication device is in a fault state,
wherein the handover timing information acquisition unit acquires a determination result of the fault determination unit as the handover timing information, and
wherein the internal state output unit outputs the internal state information when the communication device is in the fault state.

9. The communication device according to claim 6,
wherein the handover timing information includes information about a predetermined cycle, and
wherein the internal state output unit outputs the internal state information at the predetermined cycle included in the handover timing information that has been acquired.

10. The communication device according to claim 1, wherein, at a point in time when the internal state acquisition unit has acquired the internal state information, the calculation unit is in a dormant state and the internal state acquisition unit and the internal state output unit are not in the dormant state.

11. A communication system comprising:
the communication device according to claim 1; and
a relay device configured to transmit and receive the internal state information to and from one or more communication devices,
wherein the relay device includes
a relay information acquisition unit configured to acquire the internal state information output by the communication device as relay information;
a relay information storage unit configured to store the relay information that has been acquired; and
a relay information output unit configured to output the stored relay information as the internal state information to the communication device, and
wherein the relay device is the second device.

12. The communication system according to claim 11,
wherein the internal state output unit provided in the communication device outputs the internal state information to the relay device on the basis of a predetermined cycle, and
wherein the relay information output unit provided in the relay device outputs the relay information when the relay information acquisition unit has not acquired the internal state information from the communication device for a predetermined period or more.

13. The communication system according to claim 11,
wherein the relay device further includes a shared relay information generation unit configured to generate shared relay information on the basis of the relay information acquired from a plurality of communication devices,
wherein the relay information storage unit stores the shared relay information as the relay information, and
wherein the relay information output unit outputs the shared relay information as the relay information.

14. The communication system according to claim 13, wherein the shared relay information generation unit generates the shared relay information using the acquisition of the relay information by the relay information acquisition unit as a trigger.

15. The communication device according to claim 5, further comprising a state storage unit configured to store state information which is information acquired at a specific moment among information items changing with at least one of a position of the communication device and a time,
wherein the internal state storage unit stores information for use in calculation of the communication parameter and the state information as the internal state information in association, and
wherein the calculation unit calculates the communication parameter on the basis of the state information stored in the state storage unit and the internal state information stored in the internal state storage unit.

16. The communication device according to claim 15,
wherein the state storage unit stores a plurality of state information items acquired at a plurality of moments, and
wherein the calculation unit decides on the communication parameter on the basis of the plurality of state information items that have been accumulated.

17. A communication method comprising:
an internal state acquisition step of acquiring internal state information indicating an internal state of a first device from the first device which is a device separate from an own device;
an internal state storage step of storing the internal state information that has been acquired;
a processing step of performing a process based on the stored internal state information; and
an internal state output step of outputting the stored internal state information to a second device which is a device separate from the first device at a predetermined handover timing.

18. The communication device according to claim 2,
wherein the calculation unit calculates a communication parameter for performing information communication on the basis of the internal state information stored in the internal state storage unit, and
wherein the communication device further comprises a wireless communication unit configured to perform the information communication corresponding to the communication parameter calculated by the calculation unit.
